(19) United States
(12) Patent Application Publication
(10) Pub. No.: US 2025/0141064 A1
(43) Pub. Date: May 1, 2025

(54) ELECTRODE, ELECTRODE ASSEMBLY, AND BATTERY

(71) Applicant: SAMSUNG SDI CO., LTD., Yongin-si (KR)

(72) Inventor: Sang Jin KIM, Suwon-si (KR)

(21) Appl. No.: 18/731,155

(22) Filed: May 31, 2024

(30) Foreign Application Priority Data
Oct. 27, 2023 (KR) 10-2023-0145318

(51) Int. Cl. H01M 50/54; H01M 50/103; H01M 50/548; H01M 50/557; H01M 50/566

(52) U.S. Cl. CPC H01M 50/54; H01M 50/103; H01M 50/548; H01M 50/557; H01M 50/566

(57) ABSTRACT

An electrode, an electrode assembly, and a battery are disclosed. An electrode includes a first coated portion including an active material on a first substrate, and a first electrode terminal which is formed by cutting a portion of a first uncoated portion of the first substrate on which the active material is not applied and has a shape of which an end portion is configured to be exposed or extend to an outside of a battery.

### CROSS-REFERENCE TO RELATED APPLICATION

The present application claims priority to and the benefit of Korean Patent Application No. 10-2023-0145318, filed on Oct. 27, 2023 in the Korean Intellectual Property Office, the entire disclosure of which is incorporated herein by reference.

### BACKGROUND

### 1. Field

Aspects of embodiments of the present disclosure relate to an electrode, an electrode assembly, and a battery.

### 2. Discussion of Related Art

In general, with rapidly increasing demand for portable electronics, such as laptops, video cameras, and mobile phones, and commercialization of robots and electric vehicles, research is actively carried out to develop battery packs enabling repeated charging/discharging.

Typically, when batteries are manufactured, an electrode tab and a current collector are connected, and separate plate-shaped parts and the like are welded to the current collector to form an electrical connection portion with an external terminal. However, due to such intermediate parts, the resistance inside batteries increases during charging or discharging of the batteries, resulting in a decrease in quick charging performance and an increase in amount of heat generation.

The above information disclosed in this Background section is provided for enhancement of understanding of the background of the present disclosure, and, therefore, it may contain information that does not constitute related (or prior) art.

### SUMMARY

According to aspects of embodiments of the present disclosure, an electrode, an electrode assembly, and a battery are provided in which a structure of an electrical connection portion between a battery electrode and an external terminal is improved to decrease an internal resistance of a battery, thereby improving a charging performance of the battery,

These and other aspects and features of the present disclosure will be described in or will be apparent from the following description of some embodiments of the present disclosure.

According to one or more embodiments of the present disclosure, an electrode includes a first coated portion including an active material on a first substrate, and a first electrode terminal which is formed by cutting a portion of a first uncoated portion of the first substrate on which the active material is not applied and has a shape of which an end portion is configured to be exposed or extend to an outside of a battery.

The first electrode terminal may include a plurality of branch extension portions spaced apart from each other and connected to the first coated portion, at least one connection portion configured to connect the branch extension portions to each other, and at least one external terminal connected to the at least one connection portion and extending to the outside of the battery, wherein a number or a width of the at least one external terminal is less than that of the branch extension portions.

The branch extension portion, the at least one connection portion, and the at least one external terminal may extend to form a continuous flat surface with the first coated portion.

The plurality of branch extension portions may include a first branch extension portion located at a position spaced apart from a first edge of the first uncoated portion, a second branch extension portion located at a position spaced apart from a second edge of the first uncoated portion, a width formed by both the second branch extension portion and the first branch extension portion being less than that of the first coated portion, and a first hole passing between the first branch extension portion and the second branch extension portion.

The first hole may include a first hole end adjacent the first branch extension portion, a second hole end adjacent the second branch extension portion, a third hole end adjacent the first coated portion, and a fourth hole end adjacent the connection portion.

The branch extension portion may further include a third branch extension portion which spaced apart from the first branch extension portion and the second branch extension portion, a width formed by all of the third branch extension portion, the first branch extension portion, and the second branch extension portion being less than that of the first coated portion, and a second hole passing between the second branch extension portion and the third branch extension portion.

According to one or more embodiments of the present disclosure, an electrode assembly includes a first electrode including a first coated portion including an active material on a first substrate, and a first electrode terminal which is formed by cutting a portion of a first uncoated portion of the first substrate on which the active material is not applied and has a shape of which an end portion is configured to be exposed or extend to an outside of a battery, and a second electrode including a second coated portion including an active material on a second substrate, and a second electrode terminal which is formed by cutting a portion of a second uncoated portion of the second substrate on which the active material is not applied and of which an end portion is configured to be exposed or extend to the outside of the battery, wherein the first electrode and the second electrode are alternately stacked.

The first electrode may be stacked such that the first electrode terminal faces a first direction, and the second electrode may be stacked such that the second electrode terminal faces a second direction opposite to the first direction.

The first electrode and the second electrode may be stacked such that the first electrode terminal and the second electrode terminal face a first direction, the first electrode terminal and the second electrode terminal may be spaced apart from each other in a third direction, and the third direction may be perpendicular to the first direction and may be different from the first direction or a second direction opposite to the first direction.

The first electrode may be stacked such that the first electrode terminal faces a first direction, the second electrode may be stacked such that the second electrode terminal faces a third direction, and the third direction may be perpendicular to the first direction and may be different from the first direction or a second direction opposite to the first direction.

The electrode assembly may further include a binding portion configured to selectively bind a plurality of stacked first electrode terminals configured the same as to the first electrode terminal to each other and a plurality of stacked second electrode terminals configured the same as the second electrode terminal to each other.

The first electrode terminal may include a plurality of branch extension portions spaced apart from each other and connected to the first coated portion, at least one connection portion configured to connect end portions of the branch extension portions to each other, and at least one external terminal extending from the at least one connection portion and configured to extend to the outside of the battery, wherein a number or a width of the external terminals is less than that of the branch extension portions, wherein the branch extension portion includes a first branch extension portion located at a position spaced apart from a first edge of the first uncoated portion, a second branch extension portion which is located at a position spaced apart from a second edge of the first uncoated portion, a width formed by both the second branch extension portion and the first branch extension portion being less than that of the first coated portion, and a first hole passing between the first branch extension portion and the second branch extension portion.

The electrode assembly may further include a first binding portion configured to bind a plurality of stacked first branch extension portions configured the same as the first branch extension portion to each other through the first hole.

The first binding portion may be formed by binding at least a portion of a periphery of the plurality of stacked first branch extension portions with an insulating member or joining the first branch extensions to each other through welding.

The electrode assembly may further include a second binding portion configured to bind a plurality of stacked connection portions of the at least one connection portion to each other through the first hole.

The electrode assembly may further include a third binding portion configured to bind a plurality of stacked external terminals of the at least one external terminal to each other.

The third binding portion may be formed by binding at least a portion of a periphery of the plurality of stacked external terminals with a conductive member or joining the external terminals to each other through welding.

The third binding portion may be coupled to the periphery of the external terminals to form a cross-sectional shape (e.g., a set cross-sectional shape) together with the external terminals.

According to one or more embodiments of the present disclosure, a battery includes the electrode assembly, and a case in which the electrode assembly is accommodated, wherein the first electrode terminal is exposed or extends to an outside of the case.

The battery may further include a third binding portion configured to bind a plurality of stacked first electrode terminals configured the same as the first electrode terminal to each other. The third binding portion may be exposed or extend to the outside of the case.

According to an aspect of embodiments of the present disclosure, when an electrode is manufactured, by using uncoated portions, an electrode terminal, which is electrically connected to an external terminal outside a battery, can be manufactured integrally with the electrode at one time.

Thus, the number of parts can be further reduced as compared with an existing complex structure in which an electrode tab and a current collector are connected, and separate plate-shaped parts and the like are connected to the current collector to form an electrical connection portion with an external terminal. Therefore, the resistance inside a battery generated during charging or discharging of the battery can be further reduced. Accordingly, quick charging performance can be further improved, and an amount of heat generated during charging or discharging of a battery can be further reduced.

In addition, according to an aspect of embodiments of the present disclosure, a number of parts can be reduced to simplify a manufacturing process, thereby further improving productivity, reducing costs for purchasing parts, and lowering battery prices increased due to the costs. Additionally, by reducing the number of parts, a battery can be made lighter, and an energy density per weight can be improved.

In addition, according to an aspect of embodiments of the present disclosure, a binding portion can be coupled to a branch extension portion and a hole formed in an electrode terminal of an electrode to prevent or substantially prevent lifting of the electrode, thereby preventing or substantially preventing the occurrence of undesired reactions or damage to the electrode due to movement or lifting of the electrode. Accordingly, the performance and operational stability of a battery can be secured.

However, aspects and effects obtainable through the present disclosure are not limited to the above aspects and effects, and other technical aspects and effects that are not mentioned will be clearly understood by those skilled in the art from the following description of the present disclosure.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 is a schematic perspective view illustrating an example of a battery according to an embodiment of the present disclosure;

FIG. 2 is a schematic perspective view illustrating another example of a battery according to an embodiment of the present disclosure;

FIG. 3 is a schematic exploded perspective view illustrating a main part of the battery according to an embodiment of the present disclosure;

FIG. 4 is a schematic perspective view illustrating an electrode assembly according to an embodiment of the present disclosure;

FIG. 5 is a schematic exploded perspective view illustrating a main part of the electrode assembly according to an embodiment of the present disclosure;

FIG. 6 is a schematic perspective view illustrating a first electrode according to an embodiment of the present disclosure;

FIG. 7 is a schematic view illustrating a process of manufacturing the first electrode, according to an embodiment of the present disclosure;

FIG. 8 is a schematic view illustrating a process of manufacturing the first electrode, according to another embodiment of the present disclosure;

FIG. 9 is a schematic view illustrating a process of manufacturing the first electrode, according to another embodiment of the present disclosure;

FIG. 10 is a schematic view illustrating a process of manufacturing the first electrode, according to another embodiment of the present disclosure;

FIG. 11 is a schematic view illustrating a process of manufacturing the first electrode, according to another embodiment of the present disclosure;

FIG. 12 is a schematic perspective view illustrating a second electrode according to an embodiment of the present disclosure;

FIG. 13 is a schematic view illustrating a process of manufacturing the second electrode, according to an embodiment of the present disclosure;

FIG. 14 is a schematic perspective view illustrating an electrode assembly according to another embodiment of the present disclosure;

FIG. 15 is a schematic perspective view illustrating a main part of an electrode assembly according to another embodiment of the present disclosure;

FIG. 16 is a schematic perspective view illustrating a main part of an electrode assembly according to another embodiment of the present disclosure;

FIG. 17 is a schematic perspective view illustrating a main part of an electrode assembly according to another embodiment of the present disclosure;

FIG. 18 is a schematic perspective view illustrating a main part of an electrode assembly according to another embodiment of the present disclosure;

FIG. 19 is a schematic perspective view illustrating a main part of an electrode assembly according to another embodiment of the present disclosure;

FIG. 20 is a schematic perspective view illustrating an electrode assembly according to another embodiment of the present disclosure;

FIG. 21 is a schematic perspective view illustrating a first electrode of the electrode assembly of FIG. 20.

FIG. 22 is a schematic perspective view illustrating a main part of an electrode assembly according to another embodiment of the present disclosure;

FIG. 23 is a schematic perspective view illustrating a main part of an electrode assembly according to another embodiment of the present disclosure;

FIG. 24 is a schematic perspective view illustrating a main part of an electrode assembly according to another embodiment of the present disclosure;

FIG. 25 is a schematic perspective view illustrating a battery according to another embodiment of the present disclosure;

FIG. 26 is a schematic exploded perspective view illustrating a main part of the battery of FIG. 25;

FIG. 27 is a schematic perspective view illustrating an electrode assembly according to another embodiment of the present disclosure;

FIG. 28 is a schematic exploded perspective view illustrating a main part of the electrode assembly of FIG. 27;

FIG. 29 is a schematic view illustrating a process of manufacturing a first electrode according to an embodiment of the present disclosure;

FIG. 30 is a schematic view illustrating a process of manufacturing a second electrode according to an embodiment of the present disclosure;

FIG. 31 is a schematic perspective view illustrating a battery according to another embodiment of the present disclosure;

FIG. 32 is a schematic exploded perspective view illustrating a main part of the battery of FIG. 31;

FIG. 33 is a schematic perspective view illustrating an electrode assembly according to another embodiment of the present disclosure; and

FIG. 34 is a schematic exploded perspective view illustrating a main part of the electrode assembly of FIG. 33.

### DETAILED DESCRIPTION

Herein, some embodiments of the present disclosure will be described, in further detail, with reference to the accompanying drawings. However, the terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

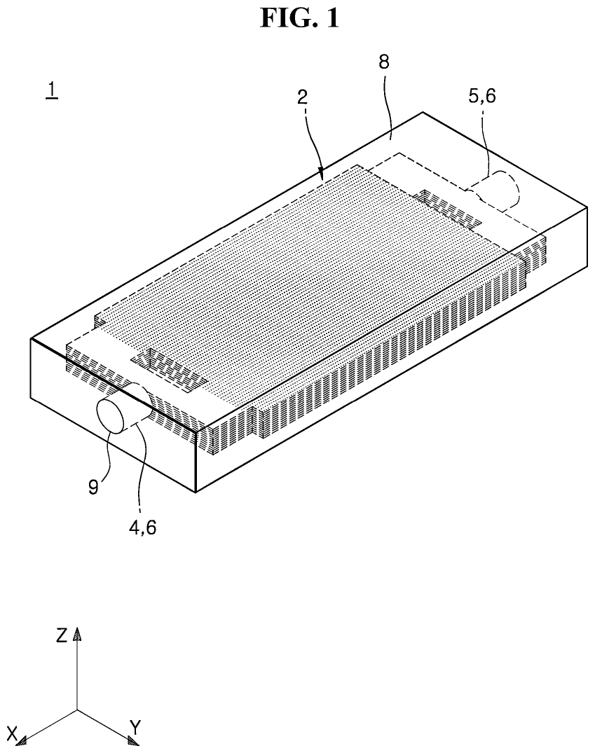

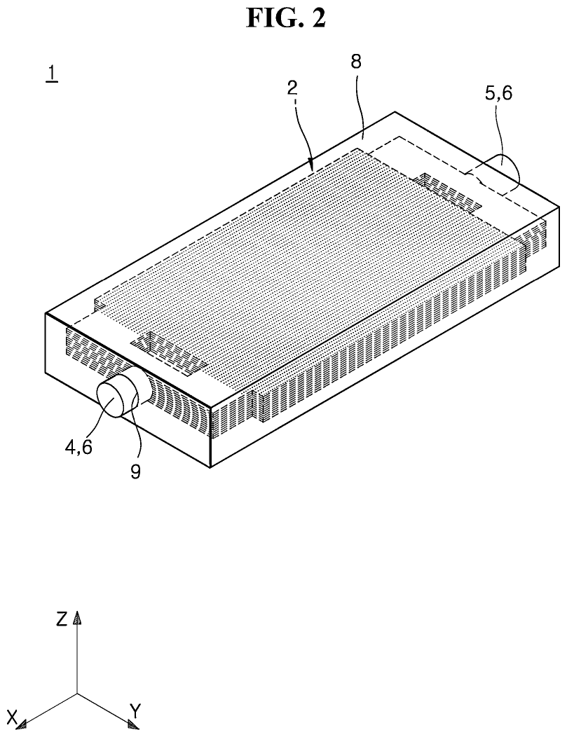

FIG. 1 is a schematic perspective view illustrating an example of a battery according to an embodiment of the present disclosure. FIG. 2 is a schematic perspective view illustrating another example of a battery according to an embodiment of the present disclosure.

Referring to FIGS. 1 and 2, a battery 1 according to the present embodiment includes an electrode assembly 2 and a case 8 in which the electrode assembly 2 is accommodated.

The electrode assembly 2 includes a first electrode 4 and a second electrode 5. Any one of the first electrode 4 and the second electrode 5 may be a positive electrode, and the other may be a negative electrode. The first electrode 4 and the second electrode 5 may be alternately stacked. A plurality of first electrodes 4 may be stacked in a first direction (e.g., an X direction), and a plurality of second electrodes 5 may be stacked in a direction different from the first direction (e.g., the X direction).

A hole 9 may be formed in the case 8 to form a path for electrical connection between the inside and the outside of the case 8. An end portion of the first electrode 4 and an end portion of the second electrode 5 provided in the electrode assembly 2 may have a shape that may be exposed to the outside through the hole 9 formed in the case 8 as shown in FIG. 1. In an embodiment, the end portion of the first electrode 4 and the end portion of the second electrode 5 may have a shape that may protrude to extend to the outside of the case 8 through the hole 9, as shown in FIG. 2. The end portion of the first electrode 4 that is exposed or protrudes to extend to the outside of the case 8 may be an end portion of a first electrode terminal 44 (described below), and the end potion of the second electrode 5 may be an end portion of a second electrode terminal 54 (described below).

The case 8 is shown as having a prismatic shape in the drawing, but the present disclosure is not limited thereto. For example, the case 8 may have any of various shapes, such as a circular shape or a pouch shape. In addition, the case 8 may be made of a metal, such as aluminum, aluminum alloy, or nickel-plated steel, or a laminated film or plastic that constitutes a pouch.

Referring to FIG. 1, at least one side of each of the end portions of the first electrode terminal 44 and the second electrode terminal 54 may be positioned close to the hole 9 inside the case 8 and may be electrically connected to an external terminal (not shown) outside the case 8 through the hole 9.

In the description of the present disclosure, the fact that the first electrode terminal 44 or the second electrode terminal 54 is exposed to the outside of the battery 1 encompasses that the first electrode terminal 44 or the second electrode terminal 54 is visible to the naked eye from the outside through the hole 9 of the case 8 and that the first electrode terminal 44 or the second electrode terminal 54 is disposed at a position directly affected by an environment outside the battery 1. In addition, as described above, the fact that the first electrode terminal 44 or the second electrode terminal 54 is exposed to the outside of the battery 1 encompasses that the first electrode terminal 44 or the second electrode terminal 54 is positioned close to the hole 9 to be directly connectable to an external terminal through the hole 9 without a separate intermediate member, or intermediary member.

In this case, the first electrode terminal 44 or the second electrode terminal 54 functions as an intermediate member for electrical connection with an external terminal. Therefore, according to the first electrode 4 or the second electrode 5, the electrode assembly 2, and the battery 1 according to an embodiment of the present disclosure, even a part corresponding to the intermediate member for connection to the external terminal may be omitted, and a number of parts may be further reduced.

Referring to FIG. 2, at least one side of each of the end portions of the first electrode terminal 44 and the second electrode terminal 54 may protrude to extend to the outside of the case 8 through the hole 9 to function as at least a portion of the external terminal. Therefore, according to the first electrode 4 or the second electrode 5, the electrode assembly 2, and the battery 1 according to an embodiment, not only an intermediate member for connection to the external terminal but also a part corresponding to the external terminal may be omitted, and a number of parts may be further reduced.

The case 8 may include a main body having a container shape capable of accommodating the electrode assembly 2 therein, and a cover coupled to block an opening of the main body. The main body of the case 8 may have a shape of which one end or two ends are open. When the hole 9 is formed at a position corresponding to each of the first electrode terminal 44 and the second electrode terminal 54, the hole 9 may be formed in each of the main body and the cover, or both of a pair of holes 9 may be formed only in the main body or only in the cover. When two covers are provided, one hole 9 may be formed for each cover.

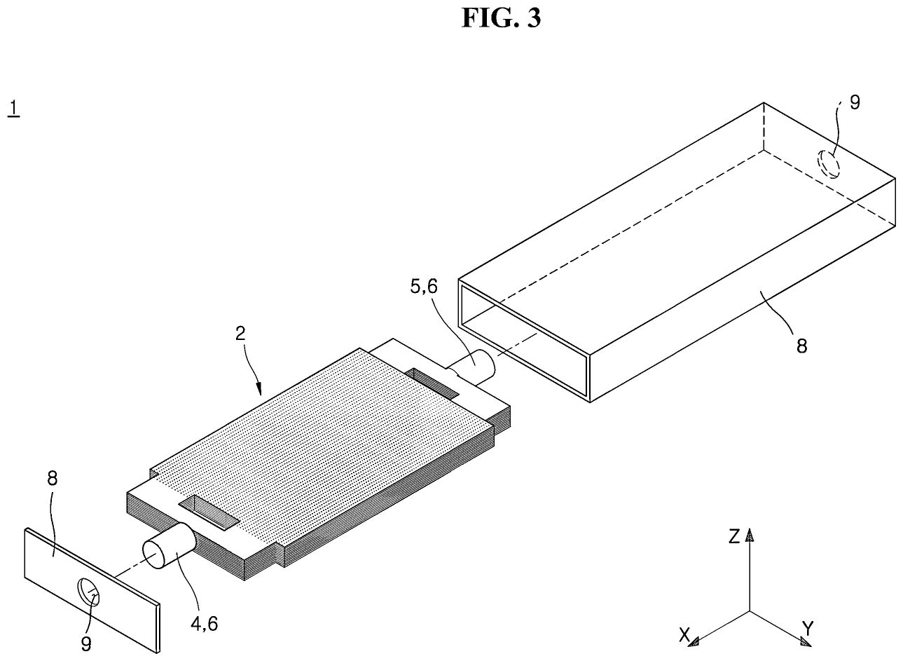

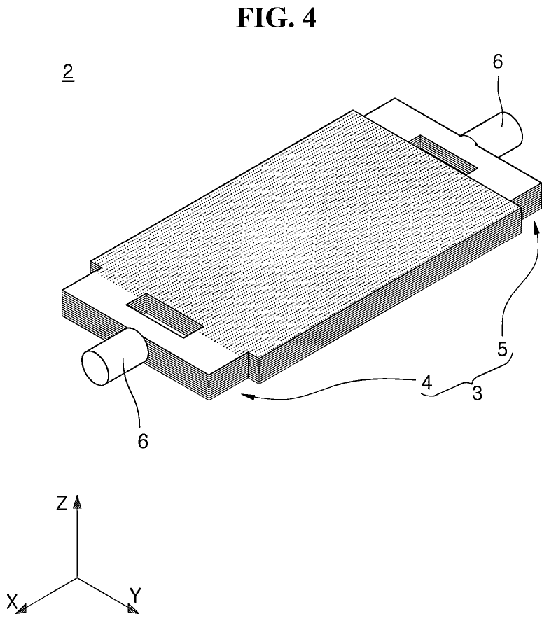

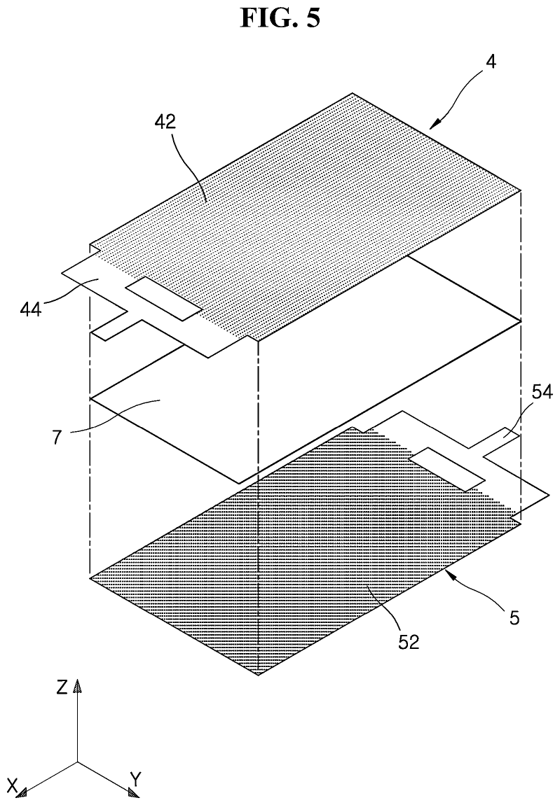

FIG. 3 is a schematic exploded perspective view illustrating a main part of the battery according to an embodiment of the present disclosure; FIG. 4 is a schematic perspective view illustrating the electrode assembly according to the embodiment of the present disclosure; and FIG. 5 is a schematic exploded perspective view illustrating a main part of the electrode assembly according to the embodiment of the present disclosure.

Referring to FIGS. 1 to 3, the battery 1 according to an embodiment of the present disclosure may have a structure in which a positive electrode terminal and a negative electrode terminal are disposed to face opposite directions. Any one of the first electrode 4 and the second electrode 5 may be a positive electrode, and the other may be a negative electrode. The battery 1 according to an embodiment of the present disclosure may include the electrode assembly 2 in which an end portion of the first electrode terminal 44 of the first electrode 4 and an end portion of the second electrode terminal 54 of the second electrode 5 are disposed to face opposite directions.

The battery 1 according to an embodiment of the present disclosure may include the case 8 in which the hole 9 (or holes) is formed at a position corresponding to each of the first electrode terminal 44 and the second electrode terminal 54. A first hole 9 may be formed in the cover of the case 8, and a second hole 9 may be formed in the main body of the case 8 at a position of the main body opposite to the cover.

The electrode assembly 2 of various embodiments, in which the first electrode terminal 44 and the second electrode terminal 54 are disposed in opposite directions, may be applied to the battery 1 according to the present embodiment of the present disclosure. In the description of the present disclosure, the electrode assembly 2 according to various embodiments will be described in further detail.

Referring to FIGS. 4 and 5, the electrode assembly 2 according to the present embodiment of the present disclosure may include the first electrode 4 and the second electrode 5 and may further include a binding portion 6.

The first electrode 4 may be a positive electrode coated with a positive electrode active material, and the second electrode 5 may be a negative electrode coated with a negative electrode active material. The first electrode 4 and the second electrode 5 may be alternately stacked. The first electrode 4 and the second electrode 5 may be stacked in a Z direction. The plurality of first electrodes 4 may be stacked such that the end portion of the first electrode terminal 44 faces the X direction. The plurality of second electrodes 5 may be stacked such that the end portion of the second electrode terminal 54 faces a −X direction which is opposite to the X direction.

A separator 7 may be disposed between the first electrode 4 and the second electrode 5. However, the present disclosure is not limited thereto, and when the electrode assembly 2 is applied to an all-solid battery, a solid electrolyte (not shown) may be used instead of the separator 7.

The binding portion 6 may selectively bind the plurality of stacked first electrode terminals 44 to each other and the plurality of stacked second electrode terminals 54 to each other. The binding portion 6 may bind first sides of the plurality of first electrode terminals 44 to each other and first sides of the plurality of second electrode terminals 54 to each other. The binding portion 6 may bind the plurality of first electrode terminals 44 to each other and may also bind the plurality of second electrode terminals 54 to each other.

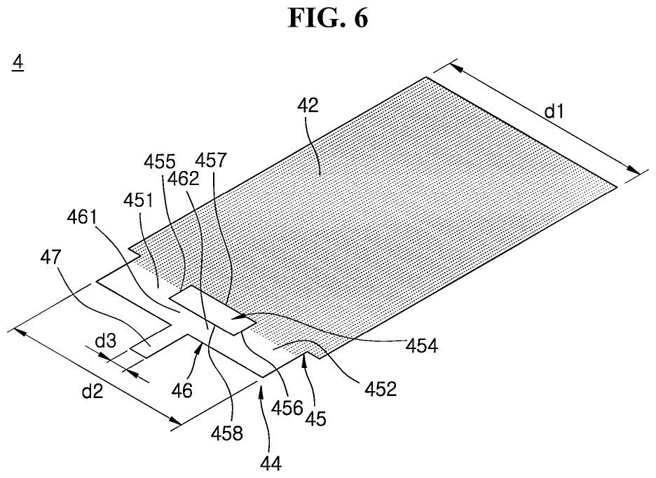

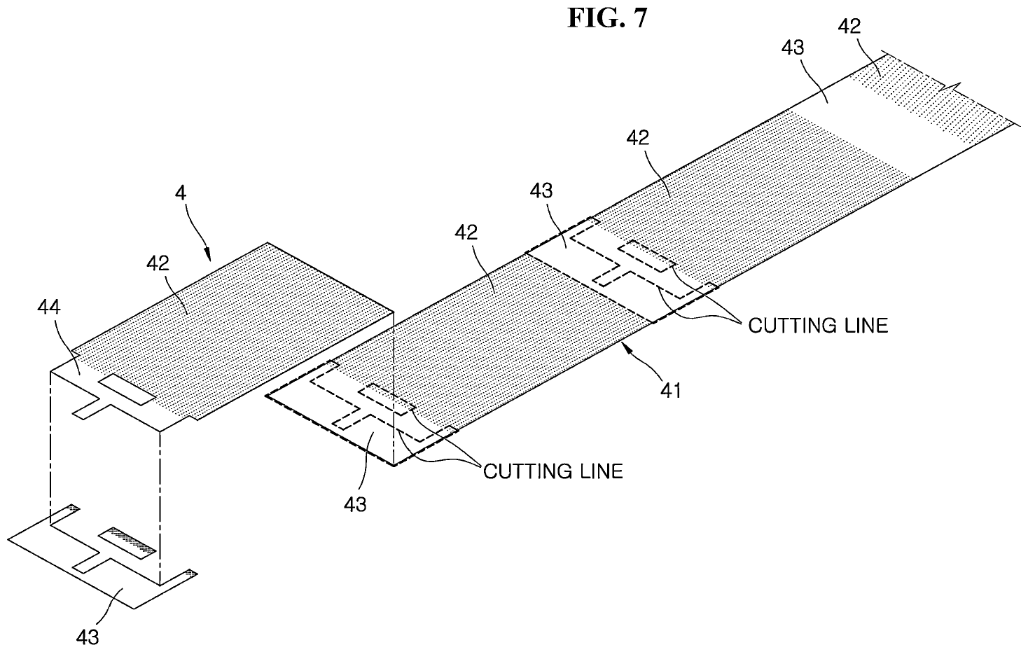

FIG. 6 is a schematic perspective view illustrating the first electrode according to an embodiment of the present disclosure; and FIG. 7 is a schematic view illustrating a process of manufacturing the first electrode, according to an embodiment of the present disclosure.

Referring to FIGS. 6 and 7, the first electrode 4 according to an embodiment of the present disclosure includes a first coated portion 42 and the first electrode terminal 44.

The first coated portion 42 may be formed by applying a positive electrode active material on a first substrate 41. The first substrate 41 may be a conductive flat member. In an embodiment, the first electrode terminal 44 may be formed integrally with the first coated portion 42 by cutting a portion of a first uncoated portion 43 of the first substrate 41 on which a positive electrode active material is not applied.

Here, the fact that the first coated portion 42 and the first electrode terminal 44 are formed integrally means that the first coated portion 42 and the first electrode terminal 44 may be manufactured using one member having one continuous frame corresponding to the first substrate 41 rather than a plurality of members, which correspond to the first coated portion 42 and the first electrode terminal 44, being individually manufactured to be connected and joined to each other.

The first substrate 41 may have a shape that has a first width d1 in a Y direction and continuously extends in the X direction. The first substrate 41 may have a plate shape on which a plurality of first coated portions 42 and a plurality of first uncoated portions 43 may be consecutively and alternately formed in the X direction. The first coated portions 42 may be formed by applying a positive electrode active material on at least one surface of the first substrate 41 at a certain width (e.g., a set width) and a certain interval (e.g., a first set interval). A portion corresponding to the first set interval may be the first uncoated portion 43 on which a positive electrode active material is not applied.

The first electrode terminal 44 may be formed by cutting a portion of the first uncoated portion 43, such as according to a previously designed terminal design. Through such a manufacturing process, the first coated portion 42 and the first electrode terminal 44 may have an integrated structure to share one frame corresponding to the first substrate 41.

The end portion of the first electrode terminal 44 has a shape that is exposed to or protrudes to extend to the outside of the case 8. Here, the fact that the end portion of the first electrode terminal 44 has a shape that may be exposed to the outside of the case 8 encompasses that the end portion of the first electrode terminal 44 is directly exposed to the outside of the case 8 and that the end portion of the first electrode terminal 44 is indirectly exposed to the outside of the case 8 while being wrapped by the binding portion 6.

When the first substrate 41 is coated with an active material in a liquid state to have a certain thickness (e.g., a set thickness), an edge of an area on which the active material is applied may have a shape of which a thickness is greater than the set thickness, an inclined shape of which a thickness is decreased toward an end, or a shape in which the active material partially agglomerates to have a non-uniform thickness. The edge of the area on which the active material is applied may be excluded from the first coated portion 42.

That is, in the area on which the active material is applied, an edge on which the active material is not applied to the set thickness may be included as a portion of the first uncoated portion 43, and the first electrode terminal 44 may be formed by cutting the first uncoated portion 43. In an embodiment, a portion of an active material may be applied on a branch extension portion 45 (described below) consecutively connected to the first coated portion 42, but the active material positioned on the branch extension portion 45 does not participate in a reaction between the electrodes 4 and 5.

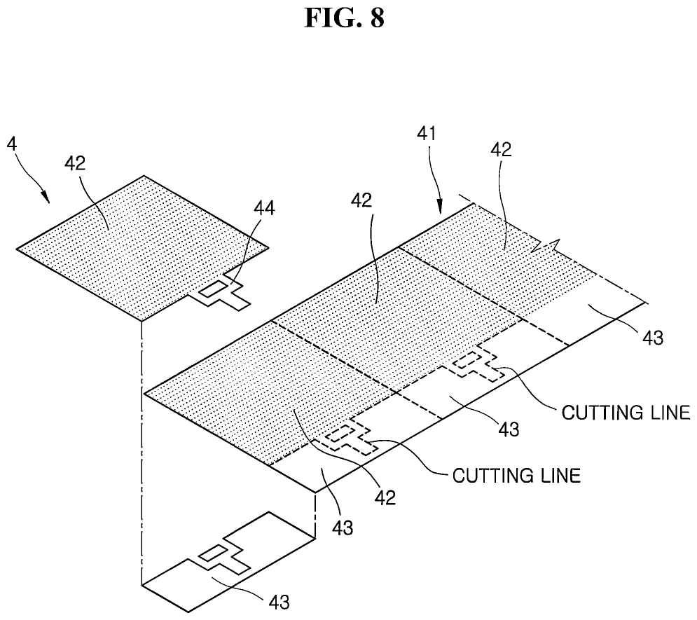

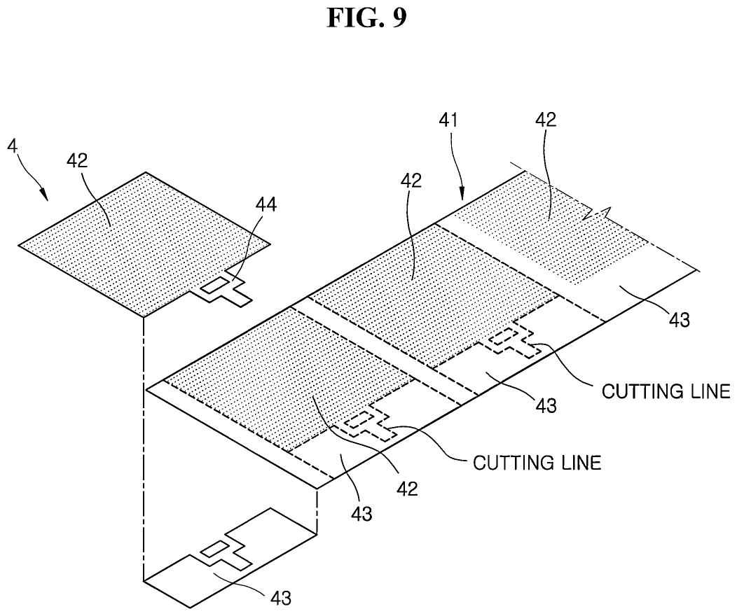

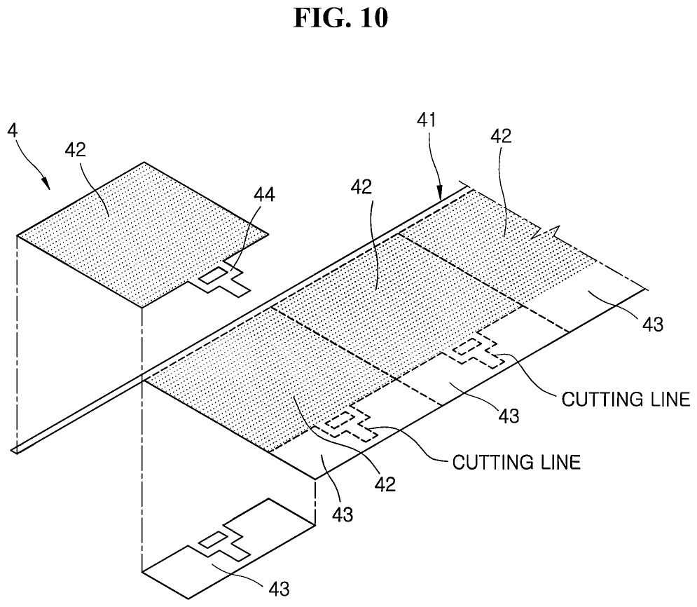

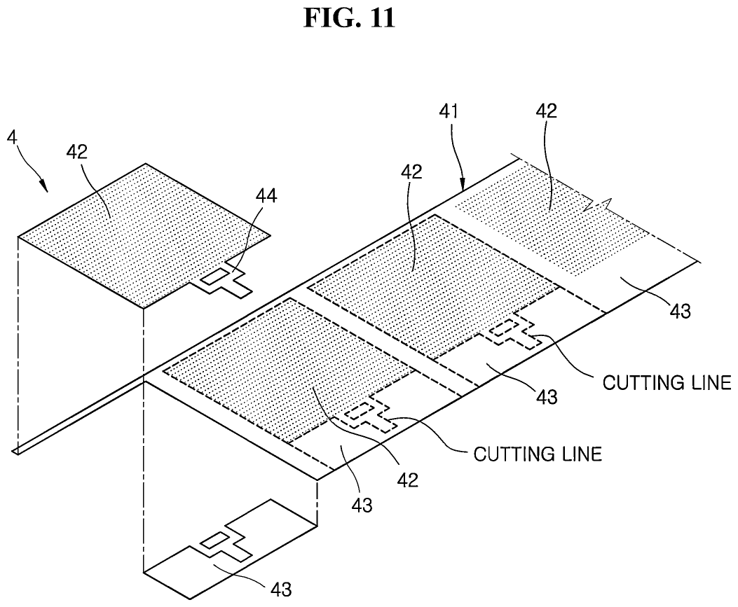

FIG. 8 is a schematic view illustrating a process of manufacturing the first electrode, according to another embodiment of the present disclosure. FIG. 9 is a schematic view illustrating a process of manufacturing the first electrode, according to another embodiment of the present disclosure. FIG. 10 is a schematic view illustrating a process of manufacturing the first electrode, according to another embodiment of the present disclosure. FIG. 11 is a schematic view illustrating a process of manufacturing the first electrode, according to another embodiment of the present disclosure.

In manufacturing the first electrode 4 according to the present embodiment of the present disclosure, the present disclosure is not limited to the embodiment of the process of manufacturing the first electrode 4 shown in FIG. 7. In manufacturing the first electrode 4 according to the present embodiment of the present disclosure, various other methods including the embodiments of the process of manufacturing the first electrode 4 shown in FIGS. 8 to 11 may be applied to manufacture the first electrode 4.

In an embodiment, the first substrate 41 may have a band shape which has a width in the Y direction corresponding to an entire length of the first electrode 4 from the first coated portion 42 to the first electrode terminal 44 and continuously extends in the X direction. An active material may be applied on a first side of the first substrate 41 in the Y direction, and then an edge of the first coated portion 42 on which the active material is applied and a portion of the first uncoated portion 43 on which the active material is not applied may be cut together to manufacture the first electrode 4 having a structure in which the first coated portion 42 and the first electrode terminal 44 are formed integrally.

At the first side in the Y direction, a plurality of first coated portions 42 may be consecutively formed in the X direction, as shown in FIG. 8, or may be formed at intervals (e.g., set intervals) in the X direction, as shown in FIG. 9. In this case, at the other side in the Y direction, the first uncoated portions 43 may be consecutively formed in the X direction. In addition, a −Y direction end of the first coated portion 42 may match a Y direction end of the first substrate 41.

The plurality of first coated portions 42 may be formed at positions spaced apart from an edge of the first substrate 41 in the Y-direction. At positions spaced an interval (e.g., a set interval) apart from a −Y direction end of the first substrate 41 in the Y direction, the plurality of first coated portions 42 may be consecutively formed in the X direction, as shown in FIG. 10, or may be formed at intervals (e.g., set intervals) in the X direction as shown in FIG. 11. In this case, the first uncoated portions 43 may be consecutively formed in the X direction at a second side in the Y direction.

Referring to FIG. 6, the first electrode terminal 44 according to the present embodiment may include the branch extension portion 45, a connection portion 46, and an external terminal 47. The branch extension portion 45, the connection portion 46, and the external terminal 47 may extend to form a continuous flat surface together with the first coated portion 42.

The branch extension portion 45 may be a portion of the first electrode terminal 44 that is consecutively connected to the first coated portion 42. The branch extension portion 45 may have a shape that protrudes to extend from the first coated portion 42 in the X direction. Two branch extension portions 45 may be formed to include a first branch extension portion 451 and a second branch extension portion 452.

The first branch extension portion 451 and the second branch extension portion 452 may be disposed to be spaced apart from each other in the Y direction. A first hole 454 may be formed between the first branch extension portion 451 and the second branch extension portion 452. However, the first branch extension portion 451, the second branch extension portion 452, and the first hole 454 may have various shapes according to a desired terminal design.

The first branch extension portion 451 may be formed at a position a second set interval spaced apart from a −Y direction end of the first uncoated portion 43 in the Y direction. The second branch extension portion 452 may be formed at a position spaced a third set interval apart from a Y direction end of the first uncoated portion 43 in the −Y direction. The first hole 454 may be formed to pass between the first branch extension portion 451 and the second branch extension portion 452. A width d2 in the Y direction formed by all of the first branch extension portion 451, the second branch extension portion 452, and the first hole 454 may be formed to be less than a width d1 of the first coated portion 42 in the Y direction.

However, an embodiment in which the branch extension portions 45 are formed at the positions spaced apart from the −Y direction end and the Y direction end of the first uncoated portion 43 is merely one of example embodiments of the present disclosure. That is, as long as the branch extension portion 45 is applicable as a portion of the first electrode terminal 44, the branch extension portions 45 are formed at the positions spaced apart from the −Y direction end and the Y direction end of the first uncoated portion 43. A-Y direction end or a Y direction end of the branch extension portion 45 may not be spaced apart from the −Y-direction end or the Y-direction end of the first uncoated portion 43. That is, the −Y direction end or the Y direction end of the branch extension portion 45 may match the −Y direction end or the Y direction end of the first uncoated portion 43.

In an embodiment, the first branch extension portion 451 and the second branch extension portion 452 may have a linear or quadrangular shape extending in the X direction. In an embodiment, the first hole 454 may have a quadrangular shape. An edge of the first hole 454 may have a shape in which a first hole end 455, a second hole end 456, a third hole end 457, and a fourth hole end 458 are connected (e.g., consecutively connected).

The first hole end 455 may be a portion of the first hole 454 that is in contact with the first branch extension portion 451. The second hole end 456 may be a portion of the first hole 454 that is in contact with the second branch extension portion 452. The third hole end 457 may be a portion of the first hole 454 that is in contact with the first coated portion 42. The fourth hole end 458 may be a portion in contact with the connection portion 46.

The connection portion 46 may be a portion of the first electrode terminal 44 that connects a plurality of branch extension portions 45 to each other. The connection portion 46 may connect the first branch extension portion 451 and the second branch extension portion 452 to each other at a position spaced apart from the first coated portion 42 in the X direction. The external terminal 47 may be a portion of the first electrode terminal 44 that extends toward the outside of the case 8, may have a width d3 less than that of the branch extension portion 45, and may be connected to the connection portion 46.

The first coated portion 42 may have the first width d1 in the Y direction, the branch extension portion 45 and the connection portion 46 may have the second width d2 less than the first width d1, and the external terminal 47 may have the third width d3 less than the second width d2. In this way, the first electrode terminal 44 may have a shape of which a width decreases (e.g., gradually decreases) from the first coated portion 42 to an outer side of the case 8. In the present embodiment, the numbers of branch extension portions 45 and external terminals 47 are not specifically limited; however, in an embodiment, the number of external terminals 47 is less than the number of branch extension portions 45, or the width d3 of the external terminal 47 is less than that of the branch extension portion 45.

The connection portion 46 according to the present embodiment may have a linear or rectangular shape extending in the Y direction. The branch extension portion 45 and the connection portion 46 may form a “C” shape together. The connection portion 46 may have a structure in which a first connection portion 461 and a second connection portion 462 may be consecutively connected.

The first connection portion 461 may be formed to extend in the Y direction between the external terminal 47 and the first branch extension portion 451. A-Y direction end of the first connection portion 461 may be consecutively connected to the first branch extension portion 451, and a Y direction end of the first connection portion 461 may be consecutively connected to the external terminal 47 and the second connection portion 462. The second connection portion 462 may be formed to extend in the Y direction between the external terminal 47 and the second branch extension portion 452. A-Y direction end of the second connection portion 462 may be consecutively connected to the external terminal 47 and the first connection portion 461, and a Y direction end thereof may be consecutively connected to the first branch extension portion 451.

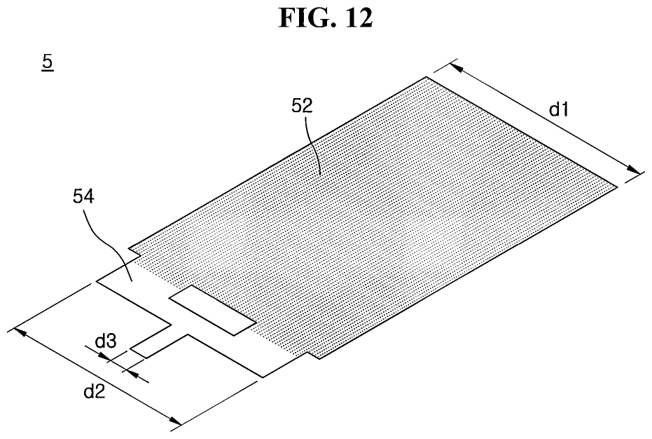

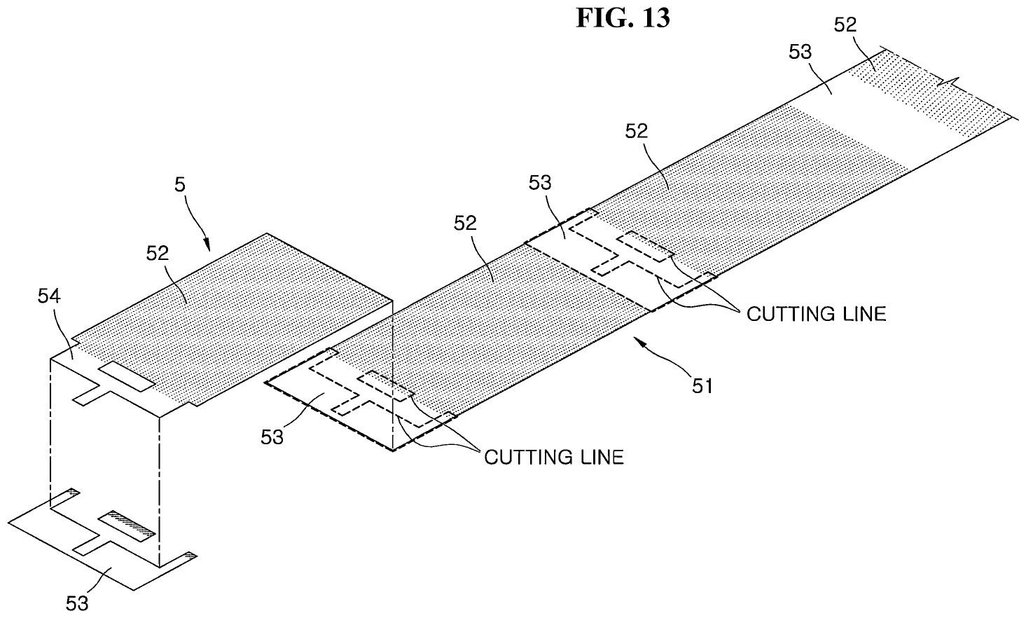

FIG. 12 is a schematic perspective view illustrating the second electrode according to an embodiment of the present disclosure; and FIG. 13 is a schematic view illustrating a process of manufacturing the second electrode according to an embodiment of the present disclosure.

Referring to FIGS. 12 and 13, the second electrode 5 according to an embodiment of the present disclosure may include a second coated portion 52 and the second electrode terminal 54.

The second coated portion 52 may be formed by applying a negative electrode active material on a second substrate 51. The second substrate 51 may be a conductive flat member. In an embodiment, the second electrode terminal 54 may be formed integrally with the second coated portion 52 by cutting a portion of a second uncoated portion 53 of the second substrate 51 on which a negative electrode active material is not applied. A plurality of second coated portions 52 may be stacked in the Z direction together with the plurality of first coated portions 42.

Here, the fact that the second coated portion 52 and the second electrode terminal 54 are formed integrally means that the second coated portion 52 and the second electrode terminal 54 may be manufactured using one member having one continuous frame corresponding to the second substrate 51 rather than a plurality of members, which correspond to the second coated portion 52 and the second electrode terminal 54, being individually manufactured to be connected and joined to each other.

The second substrate 51 may have a shape that has a first width d1 in the Y direction and continuously extends in the X direction. The second substrate 51 may have a plate shape on which the plurality of second coated portions 52 and the plurality of second uncoated portions 53 may be consecutively and alternately formed in the X direction. The second coated portions 52 may be formed by applying a positive electrode active material on at least one surface of the first substrate 41 at a width (e.g., a set width) and an interval (e.g., a set interval). A portion corresponding to the set interval may be the second uncoated portion 53 on which a positive electrode active material is not applied.

The second electrode terminal 54 may be formed by cutting a portion of the second uncoated portion 53, such as according to a previously designed terminal design. Through such a manufacturing process, the second coated portion 52 and the second electrode terminal 54 may have an integrated structure to share one frame corresponding to the second substrate 51. The second electrode 5 may be manufactured with a same design as the first electrode 4 and then disposed to face a direction opposite to the first electrode 4.

The end portion of the second electrode terminal 54 has a shape that may be exposed or protrude to extend to the outside of the case 8. Here, the fact that the end portion of the second electrode terminal 54 has a shape that may be exposed to the outside of the case 8 encompasses that the end portion of the second electrode terminal 54 is directly exposed to the outside of the case 8 and that the end portion of the second electrode terminal 54 is indirectly exposed to the outside of the case 8 while being wrapped by the binding portion 6.

Referring to FIG. 12, the second electrode terminal 54 according to the present embodiment may have a shape or structure that is the same as or correspond to the first electrode terminal 44. The second electrode terminal 54 according to the present embodiment may have a shape or structure that is the same as or corresponding to the first electrode terminal 44 including the branch extension portion 45, the connection portion 46, and the external terminal 47, and a specific description of a configuration of the second electrode terminal 54 may be substituted by the description of the first electrode terminal 44.

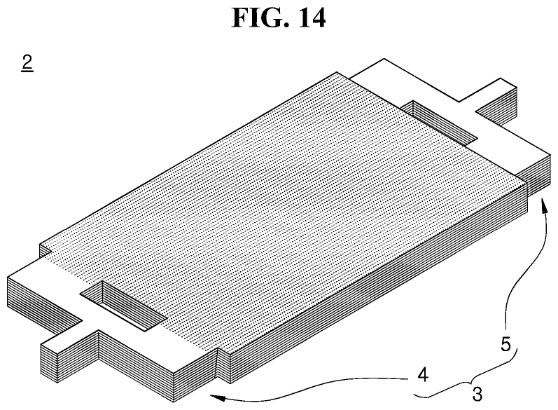

FIG. 14 is a schematic perspective view illustrating an electrode assembly according to another embodiment of the present disclosure.

An electrode assembly 2 according to the present embodiment of the present disclosure may be formed by alternately stacking a first electrode 4 and a second electrode 5 such that an end portion of a first electrode terminal 44 and an end portion of a second electrode terminal 54 face opposite directions. In the electrode assembly 2, n first electrodes 4 and n+1 second electrodes 5 may be alternately stacked to form a stack. In this case, the second electrodes 5 may be disposed at a top and a bottom of the stack. Separators 7 may be stacked between the n first electrodes 4 and the n+1 second electrodes 5. The separators 7 may be additionally disposed at the top and the bottom of the stack to provide 2 n+2 separators 7.

The plurality of first electrodes 4 may have the same shape and may be stacked in a Z direction. First coated portions 42 may be positioned on a same Z line, and the first electrode terminals 44 may be positioned on the same Z line. The plurality of second electrodes 5 may have a same shape and may be stacked in the Z direction. Second coated portions 52 may be positioned on the same Z line, and the second electrode terminals 54 may be positioned on the same Z line.

A portion of the electrode assembly 2 formed by stacking the first coated portions 42 and the second coated portions 52 may have a Z direction width (height) formed by stacking n first coated portions 42, n+1 second coated portions 52, and 2 n+2 separators 7 together.

When n first electrodes 4 are stacked, the first electrode terminals 44 are not in contact with the second electrodes 5 or the separators 7, and only the first electrode terminals 44 face each other, and a portion of the electrode assembly 2 corresponding to the first electrode terminals 44 may have a Z direction width (height) corresponding to [n×a thickness of a first substrate 41].

When n+1 second electrodes 5 are stacked, the second electrode terminals 54 are not in contact with the first electrodes 4 or the separators 7, and only the second electrode terminals 54 face each other, and a portion of the electrode assembly 2 corresponding to the second electrode terminals 54 may have a Z direction width (height) corresponding to [(n+1)×a thickness of a second substrate 51]. In the electrode assembly 2, the portion corresponding to the first electrode terminals 44 and the portion corresponding to the second electrode terminals 54 may have a thinner thickness than a portion of the electrode assembly 2 formed by stacking the first coated portions 42 and the second coated portions 52.

In the electrode assembly 2 according to the present embodiment of the present disclosure, through a joining method, such as a welding method, the plurality of first electrode terminals 44 may be integrally bound to each other, and the plurality of second electrode terminals 54 may be integrally bound to each other. Although not shown in FIG. 14, the electrode assembly 2 according to the present embodiment of the present disclosure may include a binding portion 6 corresponding to a welded portion without the use of separate binding members, such as tape, strings, clamps, or other fixing members.

When welding is performed using the binding portion 6, edges of first branch extension portions 451 may be selectively joined to each other, edges of second branch extension portions 452 may be selectively joined to each other, edges of first connection portions 461 may be selectively joined to each other, edges of second connection portions 462 may be selectively joined to each other, and edges of the external terminals 47 may be selectively joined to each other.

The plurality of first electrode terminals 44 may be bound in close contact with each other using the binding portion 6 such that a plurality of first coated portions 42, a plurality of second coated portions 52, and a plurality of separators 7 may be pressed to be in close contact with each other in the Z direction, and lifting between the first electrode 4 and the second electrode 5 may be prevented or substantially prevented. The second electrode terminals 54 may be bound in close contact with each other using the binding portion 6, thereby more firmly preventing or substantially preventing lifting between the first electrode 4 and the second electrode 5 at a different position spaced apart from the first electrode terminal 44.

When the edges of the first branch extension portions 451 are joined to each other, the edges of the second branch extension portions 452 are joined to each other, the edges of the first connection portions 461 are joined to each other, and the edges of the second connection portions 462 are joined to each other, the joining may be distributed in a plurality of places through a first hole end 455, a second hole end 456, and a fourth hole end 458 that constitute edges of a first hole 454.

Accordingly, as compared with an embodiment in which the first hole 454 is not formed, not only Y-direction and −Y-direction end portions of the first coated portion 42 and the second coated portion 52, but also Y direction middle portions of the first coated portion 42 and the second coated portion 52 may be pressed in close contact with each other in the Z direction, and lifting between the first electrode 4 and the second electrode 5 may be more firmly prevented or substantially prevented.

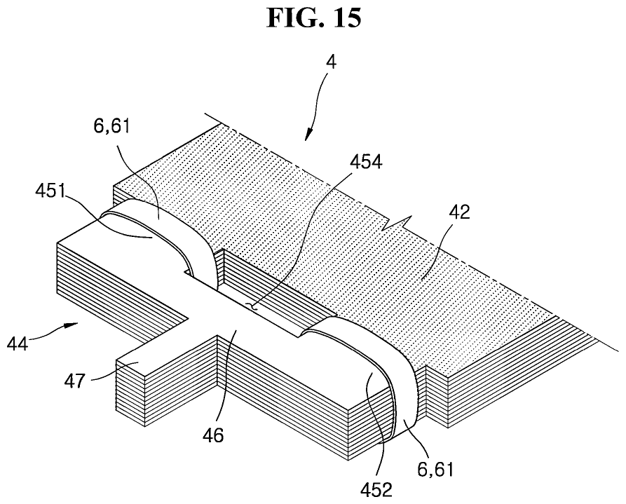

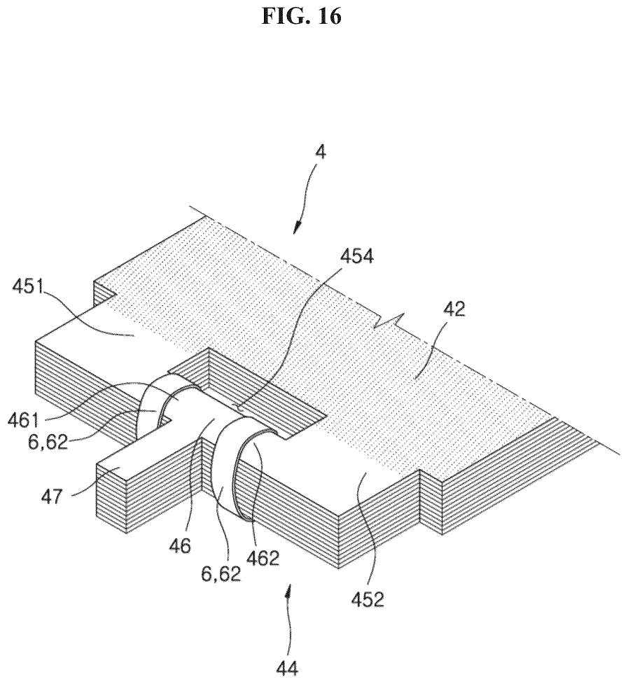

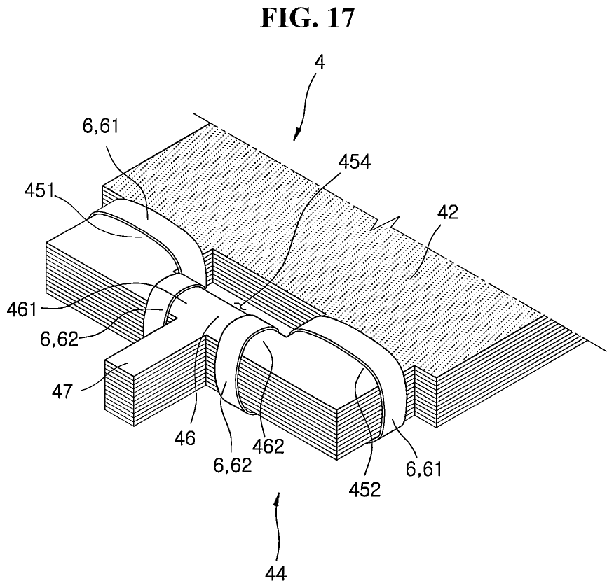

FIG. 15 is a schematic perspective view illustrating a main part of an electrode assembly according to another embodiment of the present disclosure. FIG. 16 is a schematic perspective view illustrating a main part of an electrode assembly according to another embodiment of the present disclosure. FIG. 17 is a schematic perspective view illustrating a main part of an electrode assembly according to another embodiment of the present disclosure.

An electrode assembly 2 according to embodiments shown in FIGS. 15 to 19 has a structure that may be optionally applied to the electrode assembly 2 according to the embodiment shown in FIG. 14.

Referring to FIGS. 15 to 17, a binding portion 6 according to an embodiment may include a first binding portion 61 for binding a plurality of branch extension portions 45 stacked in a Z direction to each other, and/or a second binding portion 62 for binding a plurality of connection portion 46 stacked in the Z direction to each other.

The first binding portion 61 and the second binding portion 62 may be made of an insulating material and may include binding members, such as tape, strings, clamps, or other fixing members capable of binding the plurality of branch extension portions 45 to each other and binding the plurality of connection portions 46 to each other. The first binding portion 61 and the second binding portion 62 are not limited to a specific structure and shape as long as the first binding portion 61 and the second binding portion 62 may bind the plurality of branch extension portions 45 to each other and may bind the plurality of connection portions 46 to each other.

Referring to FIG. 15, the electrode assembly 2 according to an embodiment of the present disclosure may optionally include one or more first binding portions 61. In the electrode assembly 2 according to the present disclosure, a periphery of a portion formed by stacking a plurality of first branch extension portions 451 in the Z direction (vertical direction) may be wrapped by the first binding portion 61, or at least a portion of an upper portion or a lower portion thereof may be wrapped, thereby binding the plurality of first branch extension portions 451 to be in close contact with each other.

In the electrode assembly 2 according to the present disclosure, a periphery of a portion formed by stacking a plurality of second branch extension portions 452 in the Z direction (vertical direction) may be wrapped by the first binding portion 61, or at least a portion of an upper portion or a lower portion thereof may be wrapped, thereby binding the plurality of second branch extension portions 452 to be in close contact with each other.

The first binding portion 61 may be coupled by encompassing and surrounding a periphery of the plurality of first branch extension portions 451 stacked in the Z direction through the first hole 454. A portion of the first binding portion 61 surrounding the periphery of the first branch extension portions 451 passes through the first hole 454 in the Z direction while being in contact with the first hole end 455. The plurality of first branch extension portions 451 may be bound and fixed in close contact with each other by the first binding portion 61.

The first binding portion 61 may be coupled to the second branch extension portions 452 while encompassing and surrounding a periphery of the plurality of second branch extension portions 452 stacked in the Z direction through the first hole 454. A portion of the first binding portion 61 surrounding the periphery of the second branch extension portions 452 passes through the first hole 454 in the Z direction while being in contact with the second hole end 456. The plurality of second branch extension portions 452 may be bound and fixed in close contact with each other by the first binding portion 61.

The first binding portion 61 may bind each of the plurality of first branch extension portions 451 and the plurality of second branch extension portions 452 in the form of a bundle through the first hole 454. As a width of an electrode 3 expands, a middle portion in a width direction is more likely to lift. When the first hole 454 is formed, as compared with an embodiment in which the first hole 454 is not formed, by using the plurality of first binding portions 61, an adhesion force in the Z direction may be additionally applied in a plurality of places corresponding to the first hole end 455 and the second hole end 456. Accordingly, middle portions of the first coated portion 42 and the second coated portion 52 in a Y direction may be more tightly pressed in the Z direction, and lifting between the first electrode 4 and the second electrode 5 may be more firmly prevented or substantially prevented.

As shown in FIG. 15, the first binding portion 61 may be an insulating member for binding at least a portion of the periphery of the plurality of stacked first branch extension portions 451. The first binding portion 61 may be an insulating member for binding at least a portion of the periphery of the plurality of stacked second branch extension portions 452.

In an embodiment, the first binding portion 61 may be formed by joining edges of the first branch extension portions 451 to each other through welding. In this case, a portion of the first binding portion 61 may be formed by joining the first hole ends 455 to each other through welding. In an embodiment, the first binding portion 61 may be formed by joining edges of the second branch extension portions 452 to each other through welding. In this case, a portion of the first binding portion 61 may be formed by joining the second hole ends 456 to each other through welding (see FIG. 14).

Referring to FIG. 16, the electrode assembly 2 according to an embodiment of the present disclosure may optionally include one more second binding portions 62. In the electrode assembly 2 according to the present disclosure, a periphery of a portion formed by stacking a plurality of first connection portions 461 in the Z direction (vertical direction) may be wrapped by the second binding portion 62, or at least a portion of an upper portion or a lower portion thereof may be wrapped, thereby binding the plurality of first connection portions 461 to be in close contact with each other.

In the electrode assembly 2 according to the present disclosure, a periphery of a portion formed by stacking a plurality of second connection portions 462 in the Z direction (vertical direction) may be wrapped by the second binding portion 62, or at least a portion of an upper portion or a lower portion thereof may be wrapped, thereby binding the plurality of second connection portions 462 to be in close contact with each other.

The second binding portion 62 may be coupled by encompassing and surrounding a periphery of the plurality of first connection portions 461 stacked in the Z direction through the first hole 454. A portion of the second binding portion 62 surrounding the periphery of the first connection portions 461 passes through the first hole 454 in the Z direction while being in contact with the fourth hole end 458. The plurality of first connection portions 461 may be bound and fixed in close contact with each other by the second binding portion 62.

The second binding portion 62 may be coupled by encompassing and surrounding a periphery of the plurality of second connection portions 462 stacked in the Z direction through the first hole 454. A portion of the second binding portion 62 surrounding the periphery of the second connection portions 462 passes through the first hole 454 in the Z direction while being in contact with the fourth hole end 458. The plurality of second connection portions 462 may be bound and fixed in close contact with each other by the second binding portion 62.

The second binding portion 62 may bind each of the plurality of first connection portions 461 and the plurality of second connection portions 462 in the form of a bundle through the first hole 454. As a width of an electrode 3 expands, a middle portion in a width direction is more likely to lift. When the first hole 454 is formed, as compared with an embodiment in which the first hole 454 is not formed, by using the plurality of second binding portions 62, an adhesion force in the Z direction may be additionally applied in a plurality of places corresponding to a portion of the fourth hole end 458 and the other portion thereof. Accordingly, a first electrode terminal 44 and a second electrode terminal 54 may be more tightly pressed in the Z direction, and lifting between the first electrode 4 and the second electrode 5 may be more firmly prevented or substantially prevented.

As shown in FIG. 16, the second binding portion 62 may be an insulating member for binding at least a portion of the periphery of the plurality of stacked first connection portions 461. The second binding portion 62 may be an insulating member for binding at least a portion of the periphery of the plurality of stacked second connection portions 462.

In an embodiment, the second binding portion 62 may be formed by joining edges of the first connection portions 461 to each other through welding. In this case, a portion of the second binding portion 62 may be formed by joining the fourth hole ends 458 to each other through welding. The second binding portion 62 may be formed by joining edges of the second connection portions 462 to each other through welding. In this case, a portion of the second binding portion 62 may be formed by joining the fourth hole ends 458 to each other through welding (see FIG. 14).

Referring to FIG. 17, in the electrode assembly 2 according to an embodiment of the present disclosure, the binding portion 6 of the electrode assembly 2 according to the embodiments of the present disclosure shown in FIGS. 15 and 16 may be optionally applied. The electrode assembly 2 according to the present embodiment of the present disclosure may optionally include one or more first binding portions 61 and one or more second binding portions 62. For example, by including two first binding portions 61 and two second binding portions 62, a plurality of first electrode terminals 44 and a plurality of second electrode terminals 54 may be more tightly pressed and bound in the Z direction.

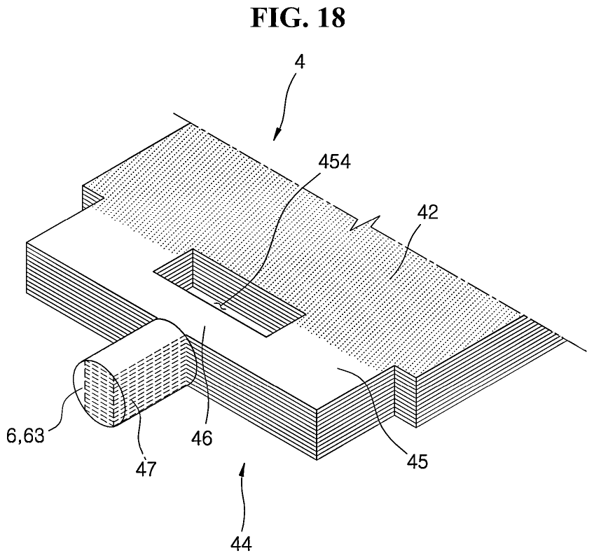

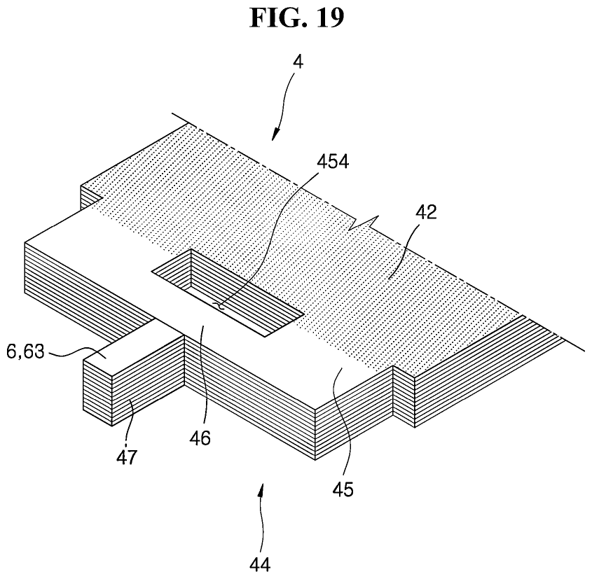

FIG. 18 is a schematic perspective view illustrating a main part of an electrode assembly according to another embodiment of the present disclosure. FIG. 19 is a schematic perspective view illustrating a main part of an electrode assembly according to another embodiment of the present disclosure.

Referring to FIGS. 18 and 19, a binding portion 6 according to an embodiment may include a third binding portion 63 for binding a plurality of external terminals 47 stacked in a Z direction to each other. The third binding portion 63 may be made of a conductive material and may include any of binding members, such as tape, strings, clamps, or other fixing members capable of binding the plurality of external terminals 47 to each other. The third binding portion 63 is not limited to a specific structure and shape as long as the third binding portion 63 may bind the plurality of external terminals 47 to each other. The third binding portion 63 may include a plate-shaped member corresponding to the first substrate 41 or the second substrate 51.

In the electrode assembly 2 according to the present disclosure, a periphery of a portion formed by stacking the plurality of external terminals 47 in the Z direction (vertical direction) may be wrapped by the third binding portion 63, or at least a portion of an upper portion or a lower portion thereof may be wrapped, thereby binding the plurality of external terminals 47 to be in close contact with each other.

The third binding portion 63 may be coupled to a periphery of the external terminals 47 to form a cross-sectional shape (e.g., a set cross-sectional shape) together with the external terminals 47. In an embodiment, referring to FIGS. 4 and 18, the third binding portion 63 may have a circular cross-sectional shape together with the plurality of external terminals 47. Referring to FIG. 19, the third binding portion 63 may have a quadrangular cross-sectional shape together with the plurality of external terminals 47.

An end portion of the first electrode terminal 44, that is, the external terminal 47, may be directly or indirectly exposed to the outside of the case 8 or may extend to the outside of the case 8 while being bound by the third binding portion 63. An end portion of the second electrode terminal 54 may be directly or indirectly exposed to the outside of the case 8 or may extend to the outside of the case 8 while being bound by the third binding portion 63.

As the binding portion 6 according to one or more embodiments of the present disclosure, one selected from the first binding portion 61, the second binding portion 62, and the third binding portion 63 as shown in FIGS. 4 and 14 to 19 may be optionally applied. In addition, various numbers and widths of the first binding portion 61, the second binding portion 62, and the third binding portion 63 may be applied according to numbers and widths of the branch extension portion 45, the connection portion 46, and the external terminal 47.

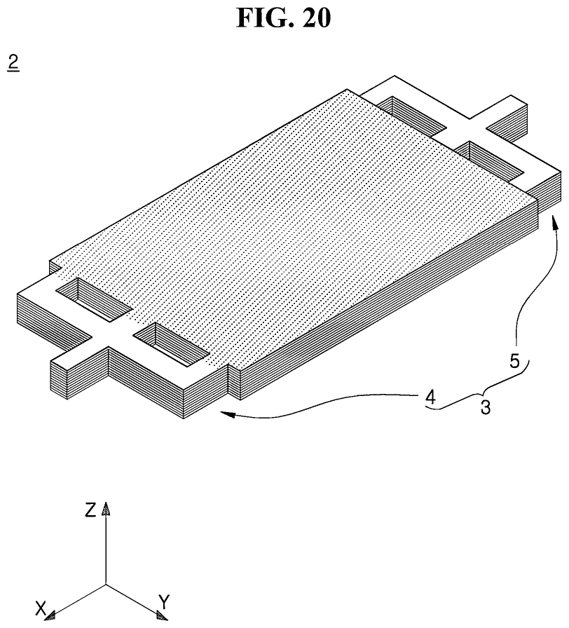

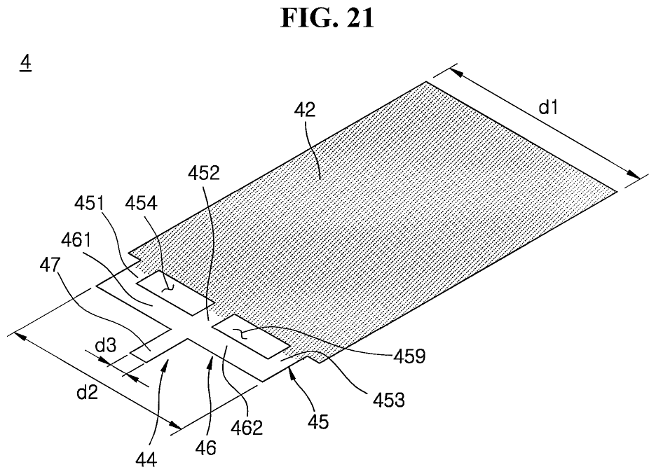

FIG. 20 is a schematic perspective view illustrating an electrode assembly according to another embodiment of the present disclosure; and FIG. 21 is a schematic perspective view illustrating a first electrode according to the embodiment of FIG. 20.

In describing an electrode assembly 2 according to the present embodiment of the present disclosure with reference to FIGS. 20 and 21, among components of the electrode assembly 2 according to the present embodiment of the present disclosure, the descriptions of the components corresponding to the components described in the description of the electrode assembly 2 according to the previously described embodiments of the present disclosure may be substituted therefor.

As compared with the electrode assembly 2 according to the embodiment of the present disclosure shown in FIG. 14, a branch extension portion 45 of a first electrode 4 of the electrode assembly 2 according to the present embodiment of the present disclosure may have a structure further including a third branch extension portion 453 and a second hole 459 in addition to a first branch extension portion 451, a second branch extension portion 452, and a first hole 454.

The third branch extension portion 453 may be disposed to be spaced apart from the first branch extension portion 451 and the second branch extension portion 452 in the Y direction. The first branch extension portion 451, the second branch extension portion 452, and the third branch extension portion 453 may be sequentially disposed along the Y direction, and the second branch extension portion 452 may be positioned at a middle portion of the first electrode 4 in a width direction. The first connection portion 461 may be positioned between the first branch extension portion 451 and the second branch extension portion 452, and the second connection portion 462 may be positioned between the second branch extension portion 452 and the third branch extension portion 453.

The second hole 459 may be formed to pass between the second branch extension portion 452 and the third branch extension portion 453. A width d2 formed by all of the first branch extension portion 451, the second branch extension portion 452, the third branch extension portion 453, the first hole 454, and the second hole 459 may be less than a width d1 of the first coated portion 42.

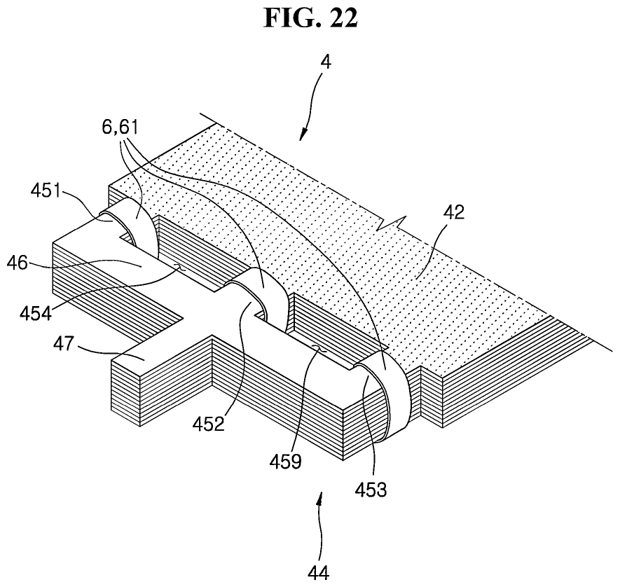

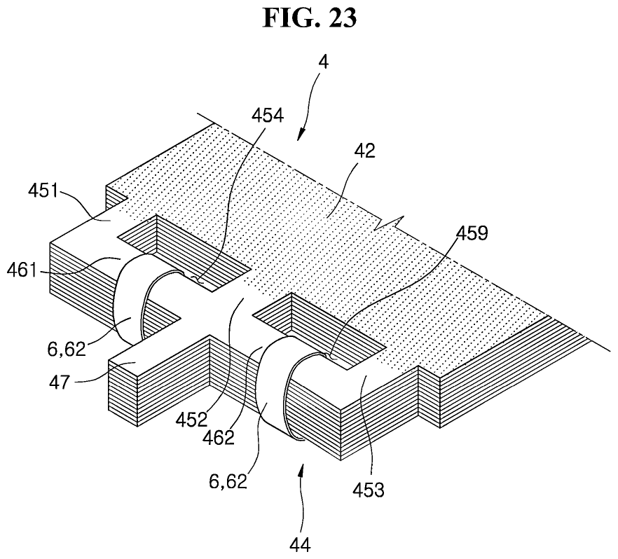

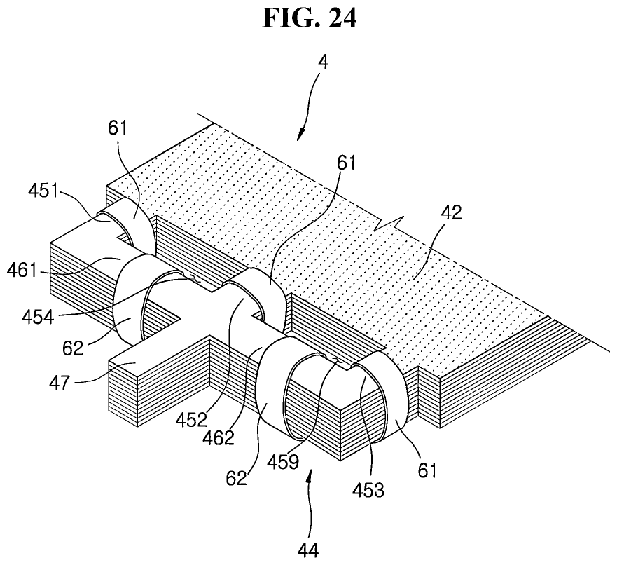

FIG. 22 is a schematic perspective view illustrating a main part of an electrode assembly according to another embodiment of the present disclosure. FIG. 23 is a schematic perspective view illustrating a main part of an electrode assembly according to another embodiment of the present disclosure. FIG. 24 is a schematic perspective view illustrating a main part of an electrode assembly according to another embodiment of the present disclosure.

An electrode assembly 2 according to the embodiments shown in FIGS. 22 to 24 has a structure that may be optionally applied to the electrode assembly 2 according to the embodiment shown in FIG. 20.

Referring to FIG. 22, the electrode assembly 2 according to the present embodiment of the present disclosure may include three first binding portions 61, each connected to a corresponding one of a first branch extension portion 451, a second branch extension portion 452, and a third branch extension portion 453. As compared with the electrode assembly 2 according to the embodiment shown in FIG. 15, the electrode assembly 2 according to the present embodiment of the present disclosure may further include the first binding portion 61 connected to the third branch extension portion 453.

The three first binding portions 61 may be connected to the first branch extension portion 451, the second branch extension portion 452, and the third branch extension portion 453 through a first hole 454 and a second hole 459. As the number of first binding portions 61 increases, first coated portions 42 may be more tightly brought into close contact with each other.

The first binding portion 61 may bind a plurality of first branch extension portions 451 to each other through the first hole 454. The first binding portion 61 may bind a plurality of third branch extension portions 453 to each other through the second hole 459. The first binding portion 61 may bind the second branch extension portions 452 to each other through the first hole 454 and the second hole 459.

Since the second branch extension portion 452 is positioned at a middle portion of a first electrode 4 in a width direction, the first binding portion 61 may be coupled to a periphery of the second branch extension portions 452, thereby more tightly bringing middle portions of coated portions 42 into close contact with each other. In this case, a portion of the first binding portion 61 surrounding the periphery of the second branch extension portions 543 passes through the first hole 454 in a Z direction, and the other portion of the first binding portion 61 passes through the second hole 459 in the Z direction.

When an electrode 3 is moved or lifted, a side reaction may occur, or the electrode 3 may be damaged. According to an embodiment of the present disclosure, lifting of the electrode 3 may be prevented or substantially prevented using one or more branch extensions 45, holes 454 and 459, and binding portions 6 to prevent or substantially prevent undesired side reactions from occurring, thereby securing the performance and operational stability of the battery 1.

Referring to FIG. 23, the electrode assembly 2 according to the present embodiment of the present disclosure may include a second binding portion 62 coupled to a periphery of a first connection portion 461 between a first branch extension portion 451 and a second branch extension portion 452. The electrode assembly 2 may include a second binding portion 62 coupled to a periphery of a second connection portion 462 between the second branch extension portion 452 and a third branch extension portion 453.

Referring to FIG. 24, in the electrode assembly 2 according to the present embodiment of the present disclosure, the binding portion 6 of the electrode assembly 2 according to the embodiments of the present disclosure shown in FIGS. 22 and 23 may be optionally applied. The electrode assembly 2 according to the present embodiment of the present disclosure may optionally include one or more first binding portions 61 and one or more second binding portions 62. For example, by including three first binding portions 61 and two second binding portions 62, a plurality of first electrode terminals 44 and a plurality of second electrode terminals 54 may be more tightly pressed and bound in a Z direction.

The embodiments of the first electrode terminal 44 and the second electrode terminal 54 according to the present disclosure are disclosed as example embodiments of the present disclosure; however, the present disclosure is not limited thereto. A number, widths, and positions of the branch extension portions 45, the connection portions 46, and the external terminals 47 provided in the first electrode terminal 44 and the second electrode terminal 54 according to the present disclosure may be varied and applied in various ways.

For example, as a width of an electrode 3 expands, a central portion of the electrode 3, more specifically, central portions of the first coated portion 42 and the second coated portion 52, are more likely to be lifted. As the numbers of branch extension portions 45, holes 454 and 459, and first binding portions 61 increase, the movement and lifting of the electrode 3 can be more firmly prevented or substantially prevented. Therefore, as the width of the electrode 3 expands, the numbers of branch extension portions 45 and holes 454 and 459 can be increased to prevent or substantially prevent the electrode 3 from moving and lifting.

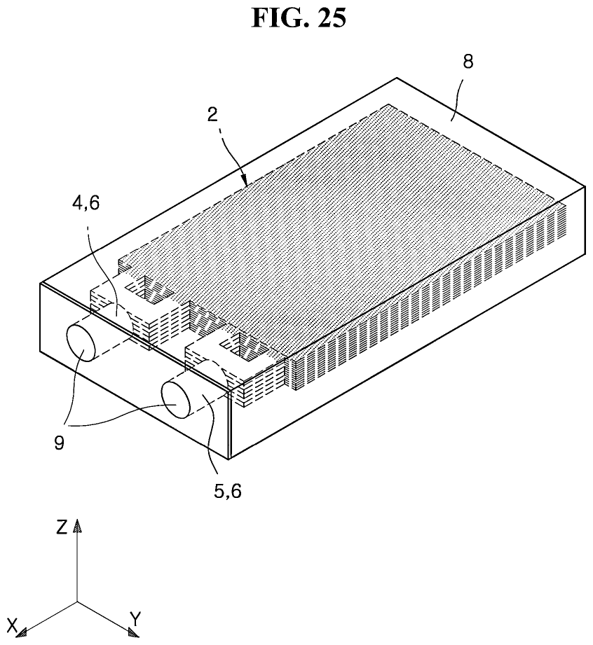

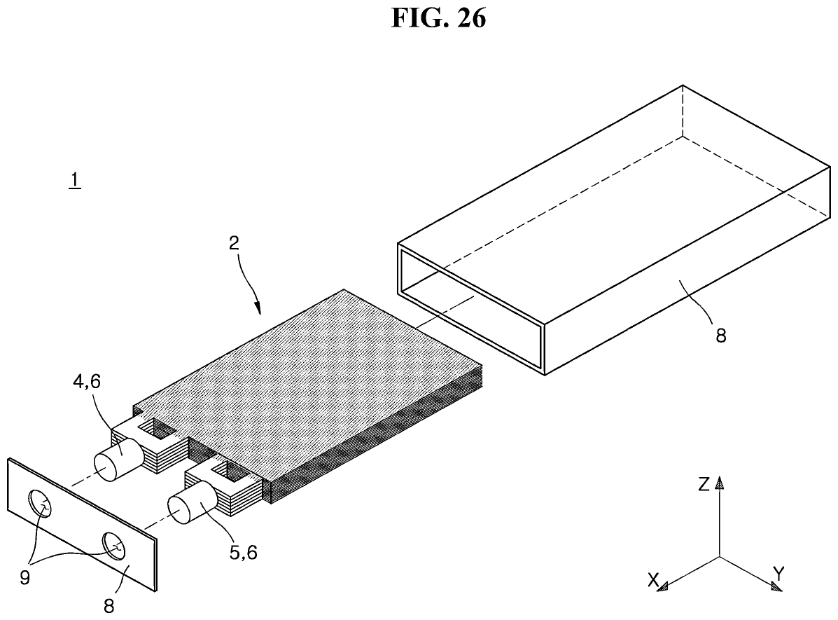

FIG. 25 is a schematic perspective view illustrating a battery according to a another embodiment of the present disclosure; and FIG. 26 is a schematic exploded perspective view illustrating a main part of the battery of FIG. 25.

Referring to FIGS. 25 and 26, a battery 1 according to the present embodiment of the present disclosure may have a structure in which a positive electrode terminal and a negative electrode terminal are disposed to face a same direction. For example, the positive electrode terminal and the negative electrode terminal may be disposed to face an X direction.

The battery 1 according to the present embodiment of the present disclosure may include an electrode assembly 2 in which an end portion of a first electrode terminal 44 of a first electrode 4 and an end portion of a second electrode terminal 54 of a second electrode 5 are disposed to face the same direction.

The battery 1 according to the present embodiment of the present disclosure may include a case 8 in which a hole 9 is formed at a position corresponding to each of the first electrode terminal 44 and the second electrode terminal 54. Two holes 9 may be formed in a cover forming a surface of the case 8 in the X direction in parallel. When a main body of the case 8 forms a side in the X direction, two holes 9 may be formed in the main body of the case 8.

The electrode assembly 2 of various embodiments in which the first electrode terminal 44 and the second electrode terminal 54 are disposed to face the same direction may be applied to the battery 1 according to the present embodiment of the present disclosure. The electrode assembly 2 provided in the battery 1 according to the present embodiment of the present disclosure may have a structure including a first electrode 4, a second electrode 5, and a binding portion 6 of any one of the electrode assemblies 2 according to the above-described embodiments, which are described as an example in the description of the battery 1 according to the embodiment shown in FIG. 4, or a selective combination of at least some thereof.

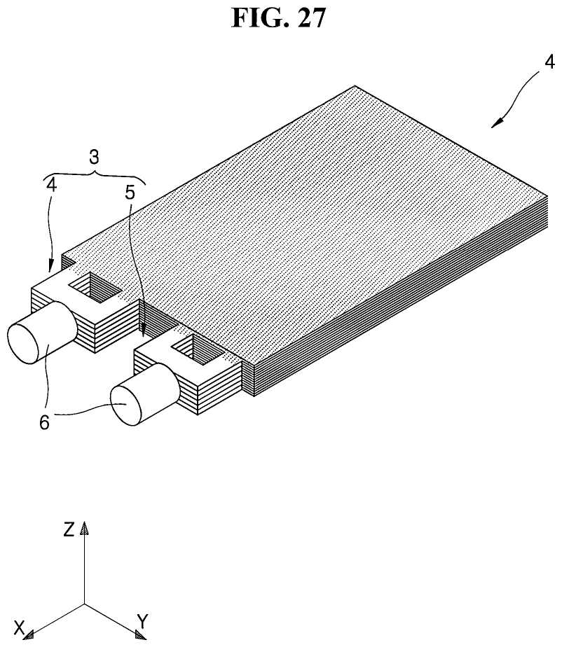

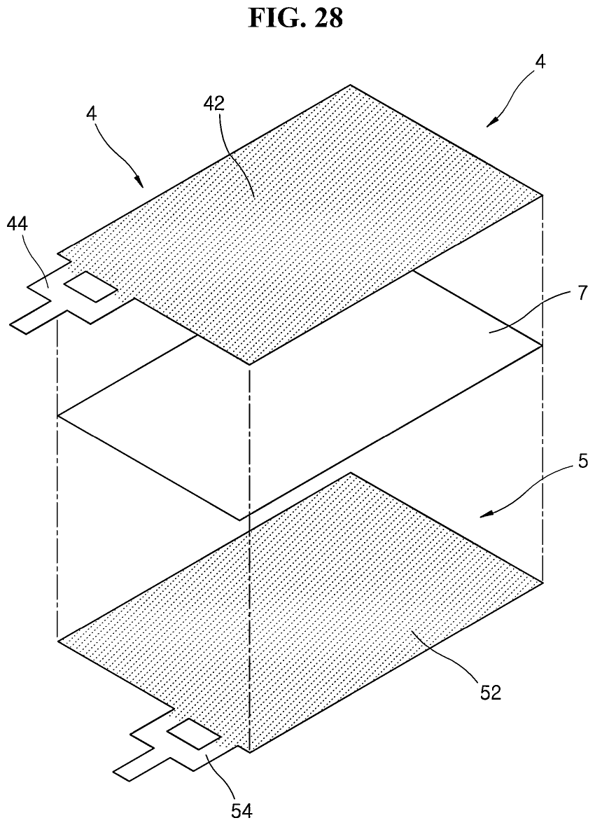

FIG. 27 is a schematic perspective view illustrating an electrode assembly according to another embodiment of the present disclosure; and FIG. 28 is a schematic exploded perspective view illustrating a main part of the electrode assembly of FIG. 27.

Referring to FIGS. 27 and 28, like the electrode assembly 2 according to the embodiment shown in FIG. 4, the electrode assembly 2 according to the present embodiment of the present disclosure may include a first electrode 4 and a second electrode 5 and may further include a binding portion 6.

The first electrode 4 may be a positive electrode coated with a positive electrode active material, and the second electrode 5 may be a negative electrode coated with a negative electrode active material. The first electrode 4 and the second electrode 5 may be alternately stacked. The first electrode 4 and the second electrode 5 may be stacked in a Z direction. A separator 7 may be disposed between the first electrode 4 and the second electrode 5.

A plurality of first electrodes 4 may be stacked such that an end portion of a first electrode terminal 44 faces an X direction. A plurality of second electrodes 5 may be stacked such that an end portion of a second electrode terminal 54 faces the X direction. The first electrode terminal 44 and the second electrode terminal 54 may be disposed to be spaced apart from each other in a Y direction.

The binding portion 6 may optionally bind the plurality of stacked first electrode terminals 44 to each other and the plurality of stacked second electrode terminals 54 to each other. The binding portion 6 may bind first sides of the plurality of first electrode terminals 44 to each other and first sides of the plurality of second electrode terminals 54 to each other. The binding portion 6 may bind the plurality of first electrode terminals 44 to each other and may also bind the plurality of second electrode terminals 54 to each other.

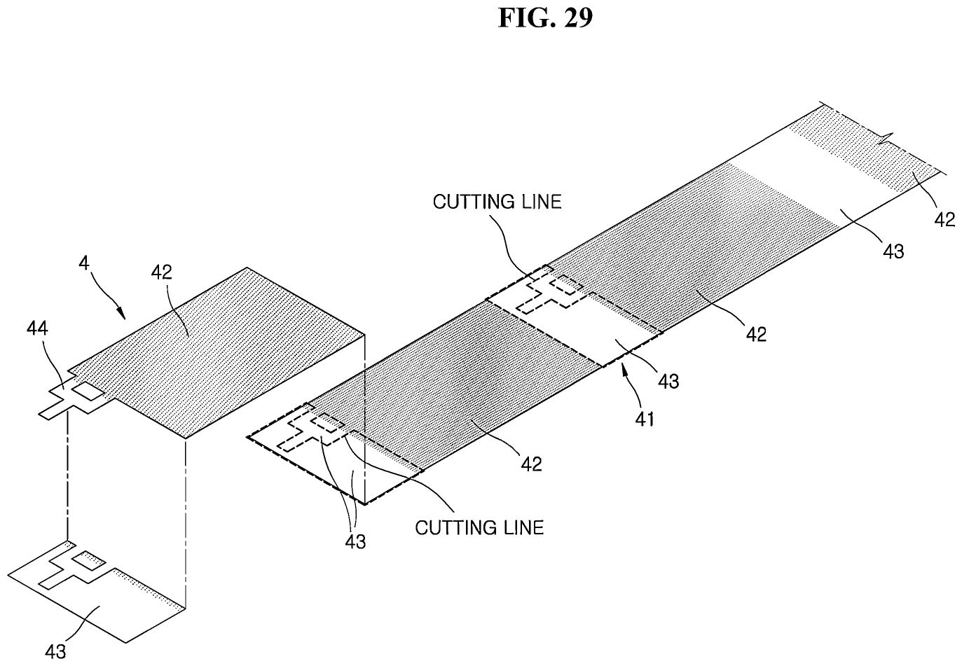

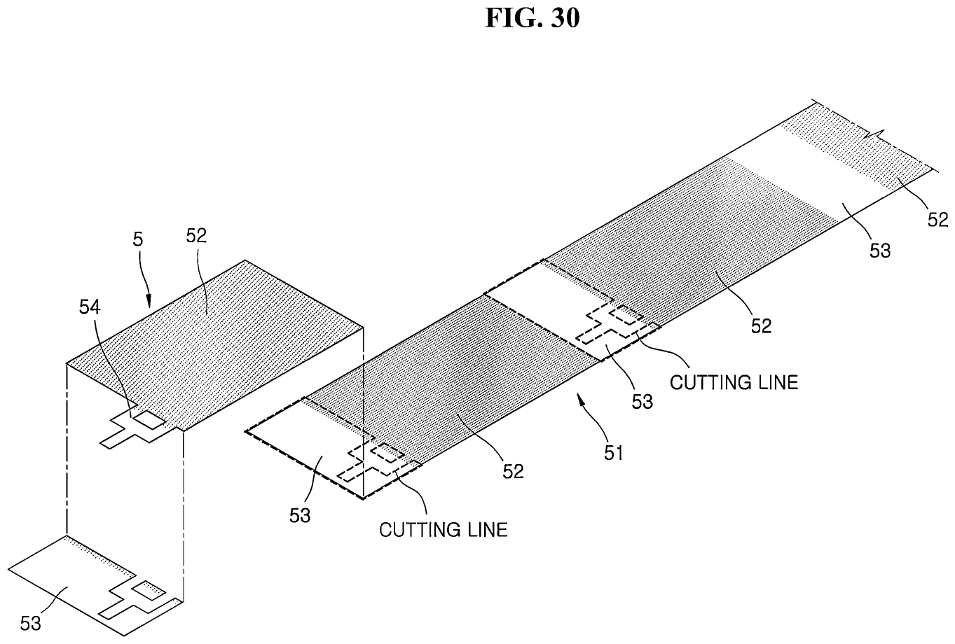

FIG. 29 is a schematic view illustrating a process of manufacturing a first electrode according to another embodiment of the present disclosure; and FIG. 30 is a schematic view illustrating a process of manufacturing a second electrode according to an embodiment of the present disclosure.

Referring to FIGS. 28 and 29, a first electrode 4 according to the present embodiment of the present disclosure includes a first coated portion 42 and a first electrode terminal 44.

The first coated portion 42 may be formed by applying a positive electrode active material on a first substrate 41. The first substrate 41 may be a conductive flat member. In an embodiment, the first electrode terminal 44 may be formed integrally with the first coated portion 42 by cutting a portion of a first uncoated portion 43 of the first substrate 41 on which a positive electrode active material is not applied.

Here, the fact that the first coated portion 42 and the first electrode terminal 44 are formed integrally means that the first coated portion 42 and the first electrode terminal 44 may be manufactured using one member having one continuous frame corresponding to the first substrate 41 rather than a plurality of members, which correspond to the first coated portion 42 and the first electrode terminal 44, being individually manufactured to be connected and joined to each other.

The first substrate 41 may have a shape that has a first width d1 in a Y direction and continuously extends in an X direction. The first substrate 41 may have a plate shape on which a plurality of first coated portions 42 and a plurality of first uncoated portions 43 may be consecutively and alternately formed in the X direction. The first coated portions 42 may be formed by applying a positive electrode active material on at least one surface of the first substrate 41 at a width (e.g., a set width) and an interval (e.g., a first set interval). A portion corresponding to the first set interval may be the first uncoated portion 43 on which a positive electrode active material is not applied (see FIGS. 6 and d1 of FIG. 12).

The first electrode terminal 44 may be formed by cutting a portion of the first uncoated portion 43, such as according to a previously designed terminal design. Through such a manufacturing process, the first coated portion 42 and the first electrode terminal 44 may have an integrated structure to share one frame corresponding to the first substrate 41.

Referring to FIGS. 28 and 30, a second electrode 5 according to the previous embodiment of the present disclosure may include a second coated portion 52 and a second electrode terminal 54.

The second coated portion 52 may be formed by applying a negative electrode active material on a second substrate 51. The second substrate 51 may be a conductive flat member. In an embodiment, the second electrode terminal 54 may be formed integrally with the second coated portion 52 by cutting a portion of a second uncoated portion 53 of the second substrate 51 on which a negative electrode active material is not applied.

Here, the fact that the second coated portion 52 and the second electrode terminal 54 are formed integrally means that the second coated portion 52 and the second electrode terminal 54 may be manufactured using one member having one continuous frame corresponding to the second substrate 51 rather than a plurality of members, which correspond to the second coated portion 52 and the second electrode terminal 54, being individually manufactured to be connected and joined to each other.

The second substrate 51 may have a shape that has a first width d1 in the Y direction and continuously extends in the X direction. The second substrate 51 may have a plate shape on which a plurality of second coated portions 52 and a plurality of second uncoated portions 53 may be consecutively and alternately formed in the X direction. The second coated portions 52 may be formed by applying a positive electrode active material on at least one surface of the second substrate 51 at a width (e.g., a set width) and an interval (e.g., a set interval). A portion corresponding to the set interval may be the second uncoated portion 53 on which a positive electrode active material is not applied (see FIGS. 6 and d1 of FIG. 12).

The second electrode terminal 54 may be formed by cutting a portion of the second uncoated portion 53, such as according to a previously designed terminal design. Through such a manufacturing process, the second coated portion 52 and the second electrode terminal 54 may have an integrated structure to share one frame corresponding to the second substrate 51. The second electrode 5 may be manufactured with the same design as the first electrode 4 and then disposed to face a direction opposite to the first electrode 4.

A plurality of second coated portions 52 may be stacked in a Z direction together with the plurality of first coated portions 42. A plurality of first electrode terminals 44 may be stacked in the Z direction. In an embodiment, the second electrode terminal 54 may have a same shape as the first electrode terminal 44. The second electrode terminal 54 may be disposed at a position spaced apart from the first electrode terminal 44 in the Y direction. A plurality of second electrode terminals 54 may be stacked in the Z direction.

The first electrode terminal 44 and the second electrode terminal 54 may be disposed in parallel in the Y direction. An end portion of the first electrode terminal 44 and an end portion of the second electrode terminal 54 may have a shape that may be exposed to the outside of an X-direction end of a case 8 or may extend to the outside of the case 8. The end portion of the first electrode terminal 44 and the end portion of the second electrode terminal 54 may be positioned in parallel on a surface of the case 8 in the X direction.

Here, the fact that the end portion of the first electrode terminal 44 and the end portion of the second electrode terminal 54 have a shape that may be exposed to the outside of the case 8 encompasses that the end portion of the first electrode terminal 44 and the end portion of the second electrode terminal 54 are directly exposed to the outside of the case 8 and that the end portion of the first electrode terminal 44 and the end portion of the second electrode terminal 54 are indirectly exposed to the outside of the case 8 while being wrapped by a binding portion 6.

The first coated portion 42 of the first electrode 4 may have a first width d1 in the Y direction. The second coated portion 52 of the second electrode 5 may have a first width d1 in the Y direction. The first electrode terminal 44 may have a shape of which a width decreases (e.g., gradually decreases) from the first coated portion 42 to an outer side of the case 8. The second electrode terminal 54 may have a shape of which a width decreases (e.g., gradually decreases) from the second coated portion 52 to an outer side of the case 8.

The first electrode terminal 44 may have a width that is less than the first width d1. The second electrode terminal 54 may have a width that is less than the first width d1. A width in the Y direction formed by both of the first electrode terminal 44 and the second electrode terminal 54 may be a second width d2 that is less than the first width d1. Both of the end portion of the first electrode terminal 44 and the end portion of the second electrode terminal 54, which are exposed or extend to the outside of the case 8 may have a width in the Y direction which is less than the second width d2 (see FIGS. 6 and d1 and d2 of FIG. 12).

In describing the battery 1 according to the present embodiment of the present disclosure, the descriptions of components corresponding to the components described in the battery 1 according to the previously described embodiment of the present disclosure may be substituted by the description of the battery 1 according to the first embodiment.

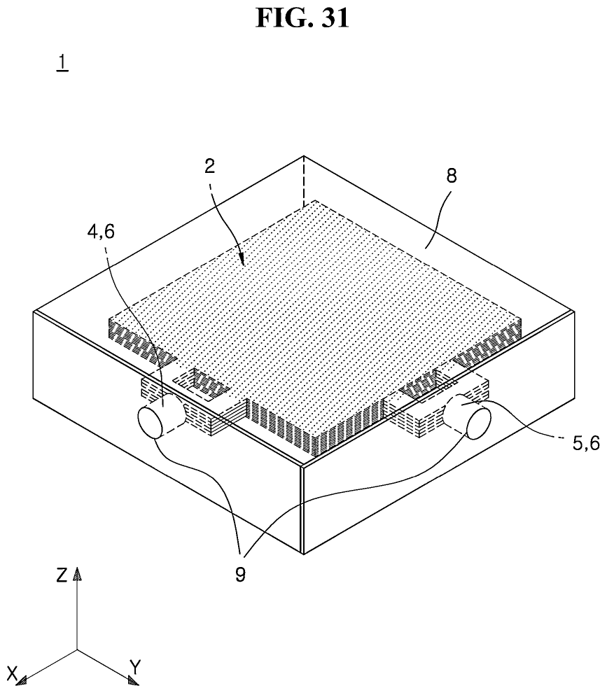

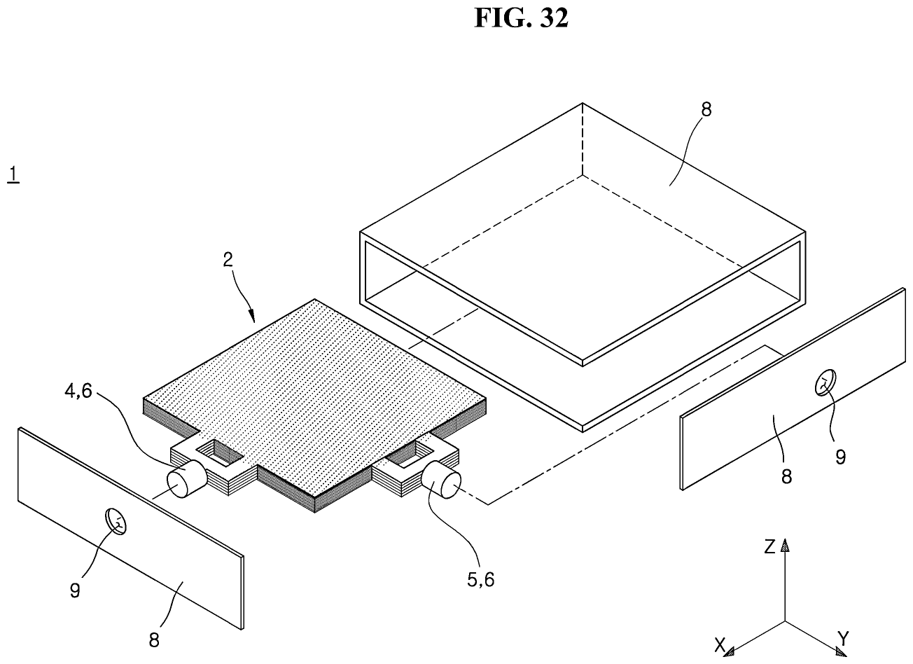

FIG. 31 is a schematic perspective view illustrating a battery according to another embodiment of the present disclosure; and FIG. 32 is a schematic exploded perspective view illustrating a main part of the battery of FIG. 31.

Referring to FIGS. 31 and 32, a battery 1 according to the present embodiment of the present disclosure may have a structure in which a positive electrode terminal and a negative electrode terminal are disposed to face different directions rather than a same direction or opposite directions. The positive electrode terminal may be disposed to face an X direction, and the negative electrode terminal may be disposed to face a direction different from the X direction or a −X direction. For example, the positive electrode terminal may be disposed to face the X direction, and the negative electrode terminal may be disposed to face a Y direction.

Any one of a first electrode 4 and a second electrode 5 may be a positive electrode, and the other may be a negative electrode. The battery 1 according to the present embodiment of the present disclosure may include an electrode assembly 2 in which an end portion of a first electrode terminal 44 of the first electrode 4 and an end portion of a second electrode terminal 54 of the second electrode 5 are disposed to face directions which form any one of an acute angle, a right angle, and an obtuse angle.

The battery 1 according to the present embodiment of the present disclosure may include a case 8 in which a hole 9 is formed at a position corresponding to each of the first electrode terminal 44 and the second electrode terminal 54. The case 8 may include a main body having an X-direction open end and a Y-direction open end, and two covers respectively coupled to the X-direction open end and the Y-direction open end. The hole 9 may be formed in each of the two covers. The end portion of the first electrode terminal 44 and the end portion of the second electrode terminal 54 may be exposed to the outside of the case 8 through the two holes 9 or may be disposed to protrude to extend to the outside of the case 8.

The electrode assembly 2 of various embodiments in which the first electrode terminal 44 and the second electrode terminal 54 are disposed to form an acute angle, a right angle, or an obtuse angle may be applied to the battery 1 according to the present embodiment of the present disclosure. The electrode assembly 2 provided in the battery 1 according to the present embodiment of the present disclosure may have a structure including a first electrode 4, a second electrode 5, and a binding portion 6 of any one of the electrode assemblies 2 according to the previously described embodiments, which are described, as an example, in the description of the battery 1 according to the embodiment shown in FIG. 4, or a selective combination of at least some thereof.

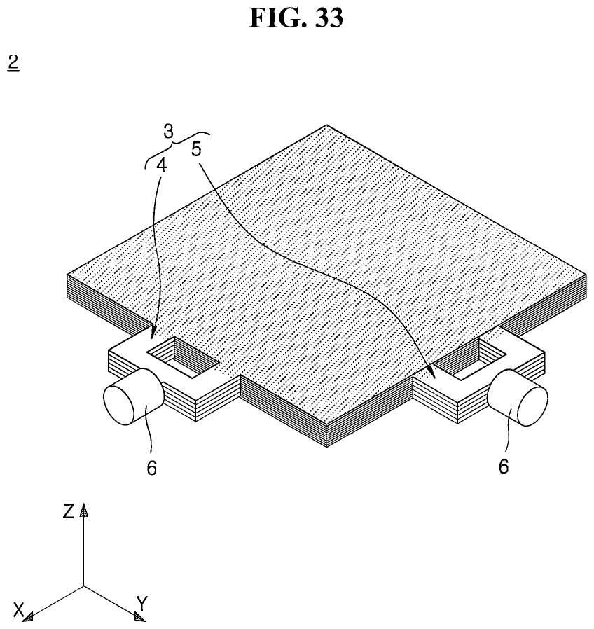

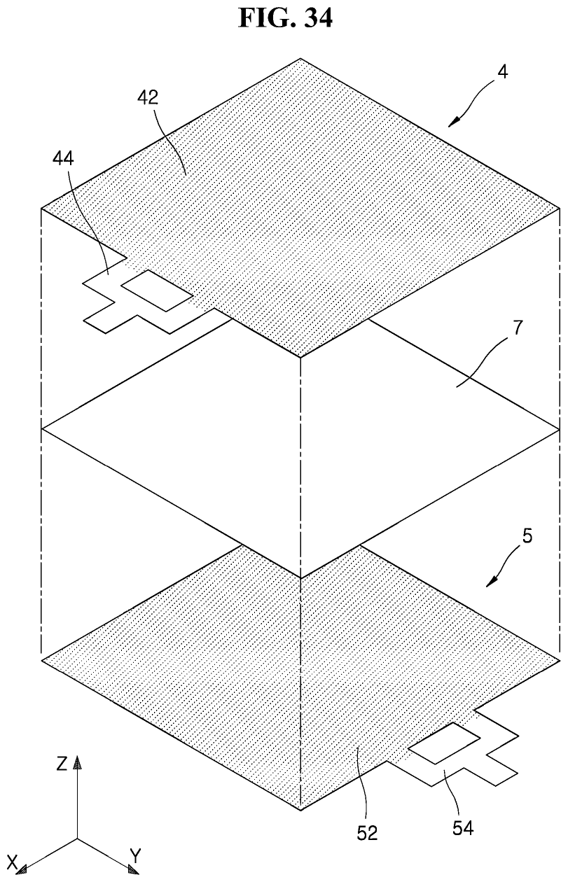

FIG. 33 is a schematic perspective view illustrating an electrode assembly according to another embodiment of the present disclosure; and FIG. 34 is a schematic exploded perspective view illustrating a main part of the electrode assembly of FIG. 33.

Referring to FIGS. 33 and 34, like the electrode assembly 2 according to the embodiment of FIG. 4, the electrode assembly 2 according to the present embodiment of the present disclosure may include a first electrode 4 and a second electrode 5 and may further include a binding portion 6.

The first electrode 4 may be a positive electrode coated with a positive electrode active material, and the second electrode 5 may be a negative electrode coated with a negative electrode active material. The first electrode 4 and the second electrode 5 may be alternately stacked. The first electrode 4 and the second electrode 5 may be stacked in a Z direction. A separator 7 may be disposed between the first electrode 4 and the second electrode 5.

A plurality of first electrodes 4 may be stacked such that an end portion of a first electrode terminal 44 faces an X direction. A plurality of second electrodes 5 may be stacked such that an end portion of a second electrode terminal 54 faces a Y direction. The plurality of second electrodes 5 may be stacked such that the end portion of the second electrode terminal 54 faces a direction different from the X direction, a −X direction, or the Y direction.

The binding portion 6 may optionally bind the plurality of stacked first electrode terminals 44 to each other and the plurality of stacked second electrode terminals 54 to each other. The binding portion 6 may bind first sides of the plurality of first electrode terminals 44 to each other and first sides of the plurality of second electrode terminals 54 to each other. The binding portion 6 may bind the plurality of first electrode terminals 44 to each other and may also bind the plurality of second electrode terminals 54 to each other.

In describing the battery 1 according to the present embodiment of the present disclosure, the descriptions of components corresponding to the components described in the battery 1 according to the previously described embodiments of the present disclosure may be substituted therefor.

The embodiments of the electrode, electrode assembly, and battery according to the present disclosure described above are disclosed as some example embodiments of the present disclosure, and the present disclosure is not limited thereto. For example, shapes of the first electrode terminal 44 and the second electrode terminal 54 according to the present disclosure are not limited to a specific shape (design) including that of the above-described embodiments as long as end portions thereof may be exposed or protrude to the outside of a case 8.

According to the electrode, electrode assembly, and battery according to the present disclosure having such a configuration, when an electrode 3 is manufactured, by using uncoated portions 43 and 53, the electrode terminals 44 and 54, which are electrically connected to external terminals (not shown) outside a battery 1, can be manufactured integrally with the electrode 3 at one time, or concurrently.

Accordingly, according to the present disclosure, a number of parts may be further reduced as compared with an existing complex structure in which an electrode tab and a current collector are connected, and separate plate-shaped parts and the like are connected to the current collector to form an electrical connection portion with an external terminal. Therefore, the resistance inside a battery generated during charging or discharging of a battery can be further reduced. Accordingly, quick charging performance can be further improved, and an amount of heat generated during charging or discharging of a battery can be further reduced.

According to the present disclosure, a number of parts can be reduced to simplify a manufacturing process, thereby further improving productivity, reducing costs for purchasing parts, and lowering battery prices increased due to the costs. Additionally, by reducing the number of parts, a battery 1 can be made lighter, and the energy density per weight (Wh/kg) can be improved.

In addition, according to the present disclosure, a binding portion 6 can be coupled to a branch extension portion 45 and holes 454 and 459 formed in electrode terminals 44 and 54 of an electrode 3 to prevent or substantially prevent lifting of the electrode 3, thereby preventing or substantially preventing the occurrence of undesired reactions or damage to the electrode 3. Accordingly, the performance and operational stability of the battery 1 can be secured.

Although the present invention has been described with reference to some example embodiments and drawings illustrating aspects thereof, the present invention is not limited thereto. Rather, various modifications and variations can be made by a person skilled in the art to which the present invention belongs within the scope of the technical spirit of the present invention and the claims and equivalents thereto.

What is claimed is:

1. An electrode comprising:
a first coated portion comprising an active material on a first substrate; and
a first electrode terminal which is formed by cutting a portion of a first uncoated portion of the first substrate on which the active material is not applied and has a shape of which an end portion is configured to be exposed or extend to an outside of a battery.

2. The electrode as claimed in claim 1, wherein the first electrode terminal comprises:
a plurality of branch extension portions spaced apart from each other and connected to the first coated portion;
at least one connection portion configured to connect the branch extension portions to each other; and
at least one external terminal connected to the at least one connection portion and configured to extend to the outside of the battery, wherein a number or a width of the at least one external terminal is less than that of the branch extension portions.

3. The electrode as claimed in claim 2, wherein the branch extension portions, the at least one connection portion, and the at least one external terminal extend to form a continuous flat surface with the first coated portion.

4. The electrode as claimed in claim 2, wherein the plurality of branch extension portions comprises:
a first branch extension portion located at a position spaced apart from a first edge of the first uncoated portion;
a second branch extension portion which located at a position spaced apart from a second edge of the first uncoated portion, a width formed by both the second branch extension portion and the first branch extension portion being less than that of the first coated portion; and
a first hole passing between the first branch extension portion and the second branch extension portion.

5. The electrode as claimed in claim 4, wherein the first hole includes:
a first hole end adjacent the first branch extension portion;
a second hole end adjacent the second branch extension portion;
a third hole end adjacent the first coated portion; and
a fourth hole end adjacent the connection portion.

6. The electrode as claimed in claim 4, wherein the branch extension portion further comprises:
a third branch extension portion spaced apart from the first branch extension portion and the second branch extension portion, a width formed by all of the third branch extension portion, the first branch extension portion, and the second branch extension portion being less than that of the first coated portion; and
a second hole passing between the second branch extension portion and the third branch extension portion.

7. An electrode assembly comprising:
a first electrode comprising a first coated portion comprising an active material on a first substrate, and a first electrode terminal which is formed by cutting a portion of a first uncoated portion of the first substrate on which the active material is not applied and has a shape of which an end portion is configured to be exposed or extend to an outside of a battery; and
a second electrode comprising a second coated portion comprising an active material on a second substrate, and a second electrode terminal which is formed by cutting a portion of a second uncoated portion of the second substrate on which the active material is not applied and of which an end portion is configured to be exposed or extend to the outside of the battery, wherein the first electrode and the second electrode are alternately stacked.

8. The electrode assembly as claimed in claim 7, wherein the first electrode is stacked such that the first electrode terminal faces a first direction, and
the second electrode is stacked such that the second electrode terminal faces a second direction opposite to the first direction.

9. The electrode assembly as claimed in claim 7, wherein the first electrode and the second electrode are stacked such that the first electrode terminal and the second electrode terminal face a first direction,
the first electrode terminal and the second electrode terminal are spaced apart from each other in a third direction, and
the third direction is perpendicular to the first direction and different from the first direction or a second direction opposite to the first direction.

10. The electrode assembly as claimed in claim 7, wherein the first electrode is stacked such that the first electrode terminal faces a first direction,
the second electrode is stacked such that the second electrode terminal faces a third direction, and
the third direction is perpendicular to the first direction and different from the first direction or a second direction opposite to the first direction.

11. The electrode assembly as claimed in claim 7, further comprising a binding portion configured to bind a plurality of stacked first electrode terminals configured the same as the first electrode terminal to each other and a plurality of stacked second electrode terminals configured the same as the second electrode terminal to each other.

12. The electrode assembly as claimed in claim 7, wherein the first electrode terminal comprises:
a plurality of branch extension portions spaced apart from each other and connected to the first coated portion;
at least one connection portion configured to connect end portions of the branch extension portions to each other; and
at least one external terminal extending from the at least one connection portions and configured to extend to the outside of the battery, wherein a number or a width of the at least one external terminal is less than that of the branch extension portions,
wherein the branch extension portion comprises:
a first branch extension portion located at a position spaced apart from a first edge of the first uncoated portion;
a second branch extension portion located at a position spaced apart from a second edge of the first uncoated portion, a width formed by both the second branch extension portion and the first branch extension portion being less than that of the first coated portion; and
a first hole passing between the first branch extension portion and the second branch extension portion.

13. The electrode assembly as claimed in claim 12, further comprising a first binding portion configured to bind a plurality of stacked first branch extension portions configured the same as the first branch extension portion to each other through the first hole.

14. The electrode assembly as claimed in claim 13, wherein the first binding portion is formed by binding at least a portion of a periphery of the plurality of stacked first branch extension portions with an insulating member or joining the first branch extensions to each other through welding.

15. The electrode assembly as claimed in claim 12, further comprising a second binding portion configured to bind a plurality of stacked connection portions of the at least one connection portion to each other through the first hole.

16. The electrode assembly as claimed in claim 12, further comprising a third binding portion configured to bind a plurality of stacked external terminals of the at least one external terminal to each other.

17. The electrode assembly as claimed in claim 16, wherein the third binding portion is formed by binding at least a portion of a periphery of the plurality of stacked external terminals with a conductive member or joining the external terminals to each other through welding.

18. The electrode assembly as claimed in claim 17, wherein the third binding portion is coupled to the periphery of the external terminals to form a cross-sectional shape together with the external terminals.

19. A battery comprising:
the electrode assembly as claimed in claim 7; and
a case in which the electrode assembly is accommodated,
wherein the first electrode terminal is exposed or extends to an outside of the case.

20. The battery as claimed in claim 19, further comprising a third binding portion configured to bind a plurality of stacked first electrode terminals configured the same as the first electrode terminal to each other,
wherein the third binding portion is exposed or extends to the outside of the case.
